(19) United States
(12) Patent Application Publication
(10) Pub. No.: US 2008/0075873 A1
(43) Pub. Date: Mar. 27, 2008

(54) COATING COMPOSITION, HYDROPHILIC MEMBER AND PRODUCTION METHOD THEREOF

(76) Inventors: Satoshi Tanaka, Ashigarakami-gun (JP); Satoshi Hoshi, Ashigarakami-gun (JP)

Correspondence Address: BIRCH STEWART KOLASCH & BIRCH, PO BOX 747, FALLS CHURCH, VA, 22040-0747, US

(21) Appl. No.: 11/856,499

(22) Filed: Sep. 17, 2007

(30) Foreign Application Priority Data
Sep. 21, 2006 (JP) P2006-256211

(51) Int. Cl. C08F 283/12; B05D 3/00

(52) U.S. Cl. 427/387; 525/475

(57) ABSTRACT

A coating composition includes (A) a thermally-decomposing polymer selected from a thermally-decomposing polymer (1) and a thermally-decomposing polymer (2); and (B) an alkoxide compound of an element selected from Si, Ti, Zr and Al, wherein the thermally-decomposing polymer (1) has a structural unit represented by the following general formula (I-a) and a structural unit represented by the following general formula (I-b), and the thermally-decomposing polymer (2) has a structural unit represented by the following general formula (II-b) and has a functional group represented by the following general formula (II-a) at the terminal of the polymer chain:

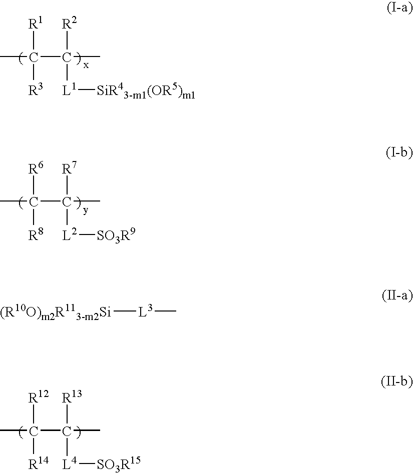

wherein the symbols in the formulae are defined in the specification.

### BACKGROUND OF THE INVENTION

1. Field of the Invention

The present invention relates to a coating composition useful for forming a hydrophilic film having excellent soiling resistance and fogging resistance and having better abrasion resistance, on the surface of various substrates, and to a hydrophilic member having a soiling-resistant and fogging-resistant surface provided with a hydrophilic film formed of the coating composition and having excellent soiling resistance.

2. Description of the Related Art

Various techniques have been proposed for preventing adhesion of oily soil to the surface of members. In particular, optical members such as antireflection films, optical filters, optical lenses, eyeglass lenses and mirrors may be soiled with fingerprints, sebum, sweat, cosmetics and the like when used by persons, whereby their functions may lower and it is troublesome to remove the soil, and therefore it is desired to apply effective anti-soiling treatment to them.

With the recent popularization of mobiles, displays have become much used in the outdoors; but when they are used in the environment in which external light is incident thereon, they cause some problems in that the incident light may make mirror reflection on them and the reflected light may mix with the display light to make the display image difficult to see. Accordingly, an antireflective optical member is often disposed on the surface of displays.

As the antireflective optical member of the type, for example, known are a laminate of a high-refractivity layer and a low-refractivity layer; a structure having a low-refractivity layer of an inorganic or organic fluoride compound singly formed on the surface of a transparent substrate; and a structure constructed by forming a coating layer containing transparent fine particles on the surface of a transparent plastic film substrate, in which the roughened surface may thereby make irregular reflection of external light on it. Like that of the above-mentioned optical members, the surface of the antireflective optical members may be readily soiled with fingerprints, sebum and the like when used by persons, and therefore they have some problems in that the only soiled part may make high reflection thereon and the soil becomes more remarkable and, in addition, the surface of the antireflection film generally has fine projections and recesses and therefore soil removal from it is difficult.

Various techniques have been proposed for forming, on the surface of solid members, an anti-soiling function having a capability of making the surface difficult to soil and a capability of facilitating removal of the soil adhering thereto. In particular, as a combination of an antireflective member and an anti-soiling member, for example, proposed are a soiling-resistant and abrasion-resistant material having an antireflection film of essentially silicon dioxide and processed with an organosilicon substituent-having compound (e.g., see JP-A 64-86101); and a soiling-resistant and abrasion-resistant CRT filter in which the substrate surface is coated with a silanol-terminated organopolysiloxane (e.g., see JP-A 4-338901). Also proposed are an antireflection film containing a silane compound such as typically a polyfluoroalkyl group-having silane compound (e.g., see JP-B 6-29332); and a combination of a thin optical film of essentially silicon dioxide and a copolymer of a perfluoroalkyl acrylate and an alkoxysilane group-having monomer (e.g., see JP-A 7-16940).

However, the soiling-resistant layer formed according to conventional methods is insufficient in point of its soiling resistance and, in particular, soil with fingerprints, sebum, cosmetics and the like is difficult to wipe off, and the surface treatment with a material having low surface energy such as fluorine, silicon or the like is problematic in that the anti-soiling capability of the treated surface may lower with time, and therefore, it is desired to develop an anti-soiling member having excellent soiling resistance and durability.

A resin film or an inorganic material of glass, metal or the like that is generally used as the surface of optical members is generally hydrophobic or weakly hydrophilic on its surface. When the surface of a substrate formed of such a resin film or an inorganic material is hydrophilicated, then water droplets adhering thereto may uniformly spread on the substrate surface to form a uniform water film thereon, and accordingly, this may be effective for preventing glass, lenses and mirrors from fogging, and may be helpful for preventing devitrification and for securing view even in rain. Further, hydrophobic pollutants, for example, combustion products such as carbon black in city dust and exhaust gas by vehicles, and also oils and fats and ingredients released from sealants may hardly adhere to it, and even if they have adhered thereto, they may be readily removed by rain or washed away with water; and therefore the resin film and the inorganic material are useful in various applications.

Surface treatment for hydrophilication heretofore proposed, for example, etching treatment or plasma treatment enable high-level surface hydrophilication, but its effect is temporary and the hydrophilicated condition could not be kept as such for a long period of time. Also proposed is a surface-hydrophilicating coating film formed of a hydrophilic graft polymer, a type of a hydrophilic resin (e.g., see Article of Daily Newspaper Chemical Industry, Jan. 30, 1995); however, though this coating film may have hydrophilicity in some degree, its affinity to substrates is not sufficient, and a coating film having higher durability is desired.

As a film having excellent surface hydrophilicity, heretofore known is a film comprising titanium oxide. For example, disclosed is a technique of forming a photocatalyst-containing layer on the surface of a substrate, and then highly hydrophilicating the surface in accordance with the optical excitation of the photocatalyst; and it is reported that, when this technique is applied to various composite materials such as glass, lenses, mirrors, exterior materials and water supply members, then it may give excellent soiling resistance to those composite materials (e.g., see WO96/29375). However, since the hydrophilic film comprising titanium oxide does not have a sufficient film strength and since it could not exhibit its hydrophilicating effect when not subjected to optical excitation, it has a problem in that its applicable sites are limited. Accordingly, an anti-soiling member having durability and having good abrasion resistance is desired.

To solve the above-mentioned problems, the characteristics of a sol-gel organic-inorganic hybrid film have been specifically noted, and it has been found that a hydrophilic surface having a crosslinked structure formed through hydrolysis and polycondensation of a hydrophilic polymer and an alkoxide has excellent fogging resistance and soiling resistance and has good abrasion resistance (see JP-A 2002-361800). The hydrophilic surface layer having such a crosslinked structure may be readily formed by combining a specific hydrophilic polymer having a reactive group at its terminal and a crosslinking agent.

### SUMMARY OF THE INVENTION

An object of the invention made in consideration of the above-mentioned problems is to provide a coating composition for use in forming, on the surface of various substrates, a hydrophilic film having excellent soiling resistance and fogging resistance and having better abrasion resistance. Another object of the invention is to provide a hydrophilic member provided with a hydrophilic film formed of the coating composition on the surface of a suitable support, and the surface of the member is excellent in the soiling resistance and fogging resistance thereof also excellent in their sustainability.

To attain the above objects, we, the present inventors have specifically noted the characteristics of a sol-gel organic-inorganic hybrid film and have promoted our studies, and as a result, have found that the above objects can be attained by a surface layer provided with a crosslinked structure formed through hydrolysis and polycondensation of a thermally-decomposing polymer or a hydrophilic polymer formed by thermally-decomposing the thermally-decomposing polymer, and an alkoxide, and further found that the surface layer having the crosslinked structure can be readily produced by a combination of a specific thermally-decomposing polymer having a crosslinkable partial structure at its terminal or a specific thermally-decomposing polymer having a crosslinkable partial structure in its side branch, and a crosslinking agent; and have completed the present invention.

A coating composition of the invention contains:

(A) a thermally-decomposing polymer selected from a thermally-decomposing polymer (1) and a thermally-decomposing polymer (2); and

(B) an alkoxide compound of an element selected from Si, Ti, Zr and Al,

wherein the thermally-decomposing polymer (1) has a structural unit represented by the following general formula (I-a) and a structural unit represented by the following general formula (I-b), and

the thermally-decomposing polymer (2) has a structural unit represented by the following general formula (II-b) and has a functional group represented by the following general formula (II-a) at the terminal of the polymer chain:

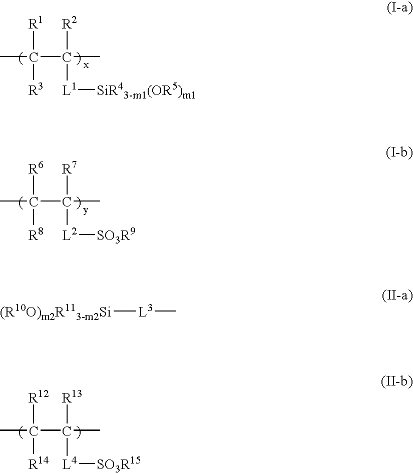

wherein R¹ to R¹⁵ each independently represents a hydrogen atom or a hydrocarbon group having 8 or less carbon atoms,

L¹, L² and L⁴ each independently represents a single bond or a polyvalent organic linking group,

L³ represents a divalent organic linking group,

m¹ and m² each independently represents an integer of from 1 to 3, and

x and y each is a number of from 0 to 100 with the proviso that x+y=100.

A hydrophilic member of the invention includes:

a support; and

a hydrophilic film that is formed by applying a coating composition onto the support and heating the coating composition, thereby decomposing a thermally-decomposing group in the coating composition to give a hydrophilic group,

wherein the coating composition contains:

(A) a thermally-decomposing polymer selected from a thermally-decomposing polymer (1) and a thermally-decomposing polymer (2), and

(B) an alkoxide compound of an element selected from Si, Ti, Zr and Al,

wherein the thermally-decomposing polymer (1) has a structural unit represented by the following general formula (I-a) and a structural unit represented by the following general formula (I-b), and

the thermally-decomposing polymer (2) has a structural unit represented by the following general formula (II-b) and has a functional group represented by the following general formula (II-a) at the terminal of the polymer chain:

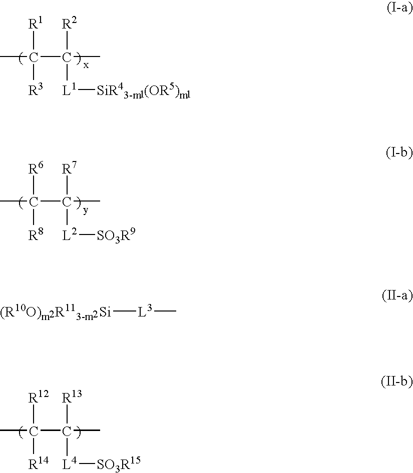

wherein R¹ to R¹⁵ each independently represents a hydrogen atom or a hydrocarbon group having 8 or less carbon atoms,

L¹, L² and L⁴ each independently represents a single bond or a polyvalent organic linking group,

L³ represents a divalent organic linking group,

m¹ and m² each independently represents an integer of from 1 to 3, and

x and y each is a number of from 0 to 100 with the proviso that x+y=100.

The hydrophilic film has a crosslinked structure constructed by preparing the above coating composition and forming it into a coating film.

The coating composition of the invention, or the coating composition used in forming the hydrophilic member of the invention preferably further contains a catalyst (C), and the catalyst (C) includes a compound that promotes the reaction of the above alkoxide compound (B) of an element selected from Si, Ti, Zr and Al (hereinafter this may be referred to as “specific alkoxide”), and the thermally-decomposing polymer (A).

A production method of the invention includes:

a process of preparing a coating composition that contains:

(A) a thermally-decomposing polymer selected from a thermally-decomposing polymer (1) and a thermally-decomposing polymer (2), and

(B) an alkoxide compound of an element selected from Si, Ti, Zr and Al;

a process of applying the coating composition onto a support;

a process of heating the coating composition to form a hydrophilic film, thereby decomposing a thermally-decomposing group in (A) the thermally-decomposing polymer to give a hydrophilic group,

wherein the thermally-decomposing polymer (1) has a structural unit represented by the following general formula (I-a) and a structural unit represented by the following general formula (I-b), and

the thermally-decomposing polymer (2) has a structural unit represented by the following general formula (II-b) and has a functional group represented by the following general formula (II-a) at the terminal of the polymer chain:

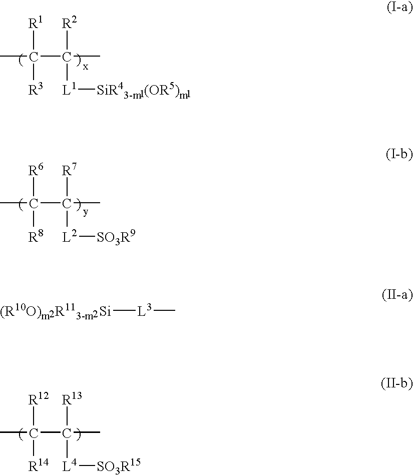

wherein R¹ to R¹⁵ each independently represents a hydrogen atom or a hydrocarbon group having 8 or less carbon atoms,

L¹, L² and L⁴ each independently represents a single bond or a polyvalent organic linking group,

L³ represents a divalent organic linking group,

m¹ and m² each independently represents an integer of from 1 to 3, and

x and y each is a number of from 0 to 100 with the proviso that x+y=100.

Another coating composition of the invention contains:

(A′) a hydrophilic polymer selected from a hydrophilic polymer (1) and a hydrophilic polymer (2); and

(B) an alkoxide compound of an element selected from Si, Ti, Zr and Al,

wherein the hydrophilic polymer (1) is formed by heating a thermally-decomposing polymer (1) having a structural unit represented by the following general formula (I-a) and a structural unit represented by the following general formula (I-b), thereby decomposing a thermally-decomposing group in the thermally-decomposing polymer (1) to give a hydrophilic group, and

the hydrophilic polymer (2) is formed by heating a thermally-decomposing polymer (2) having a structural unit represented by the following general formula (II-b) and has a functional group represented by the following general formula (II-a) at the terminal of the polymer chain, thereby decomposing a thermally-decomposing group in the thermally-decomposing polymer (2) to give a hydrophilic group:

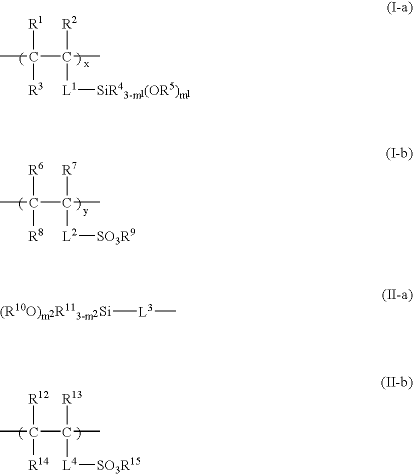

wherein R¹ to R¹⁵ each independently represents a hydrogen atom or a hydrocarbon group having 8 or less carbon atoms,

L¹, L² and L⁴ each independently represents a single bond or a polyvalent organic linking group,

L³ represents a divalent organic linking group,

m¹ and m² each independently represents an integer of from 1 to 3, and

x and y each is a number of from 0 to 100 with the proviso that x+y=100.

Another hydrophilic member of the invention includes:

a support; and

a hydrophilic film that is formed by applying a coating composition onto the support, and heating and drying the coating composition,

wherein the coating composition contains:

(A′) a hydrophilic polymer selected from a hydrophilic polymer (1) and a hydrophilic polymer (2), and

(B) an alkoxide compound of an element selected from Si, Ti, Zr and Al,

wherein the hydrophilic polymer (1) is formed by heating a thermally-decomposing polymer (1) having a structural unit represented by the following general formula (I-a) and a structural unit represented by the following general formula (I-b), thereby decomposing a thermally-decomposing group in the thermally-decomposing polymer (1) to give a hydrophilic group, and

the hydrophilic polymer (2) is formed by heating a thermally-decomposing polymer (2) having a structural unit represented by the following general formula (II-b) and has a functional group represented by the following general formula (II-a) at the terminal of the polymer chain, thereby decomposing a thermally-decomposing group in the thermally-decomposing polymer (2) to give a hydrophilic group:

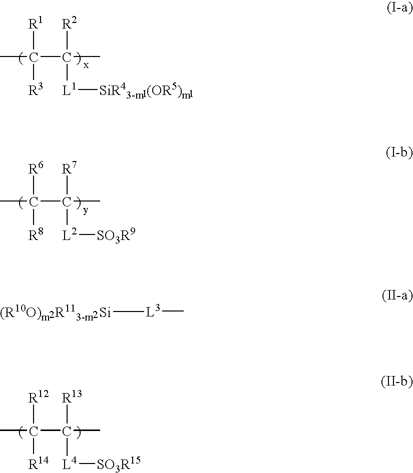

wherein R¹ to R¹⁵ each independently represents a hydrogen atom or a hydrocarbon group having 8 or less carbon atoms,

L¹, L² and L⁴ each independently represents a single bond or a polyvalent organic linking group,

L³ represents a divalent organic linking group,

m¹ and m² each independently represents an integer of from 1 to 3, and

x and y each is a number of from 0 to 100 with the proviso that x+y=100.

The hydrophilic film has a crosslinked structure constructed by preparing the above coating composition and forming it into a coating film.

The coating composition of the invention, or the coating composition used in forming the hydrophilic member of the invention preferably further contains a catalyst (C), and the catalyst (C) includes a compound that promotes the reaction of the above specific alkoxide (B) and the hydrophilic polymer (A′).

Another production method of the invention includes:

a process of preparing a coating composition that contains:

(A′) a hydrophilic polymer selected from a hydrophilic polymer (1) and a hydrophilic polymer (2), and

(B) an alkoxide compound of an element selected from Si, Ti, Zr and Al, heating (A) a thermally-decomposing polymer to form (A′) a hydrophilic polymer;

a process of applying the coating composition onto a support; and

a process of heating and drying the coating composition to form a hydrophilic film,

wherein the hydrophilic polymer (1) is formed by heating a thermally-decomposing polymer (1) having a structural unit represented by the following general formula (I-a) and a structural unit represented by the following general formula (I-b), thereby decomposing a thermally-decomposing group in the thermally-decomposing polymer (1) to give a hydrophilic group and

the hydrophilic polymer (2) is formed by heating a thermally-decomposing polymer (2) having a structural unit represented by the following general formula (II-b) and has a functional group represented by the following general formula (II-a) at the terminal of the polymer chain, thereby decomposing a thermally-decomposing group in the thermally-decomposing polymer (2) to give a hydrophilic group:

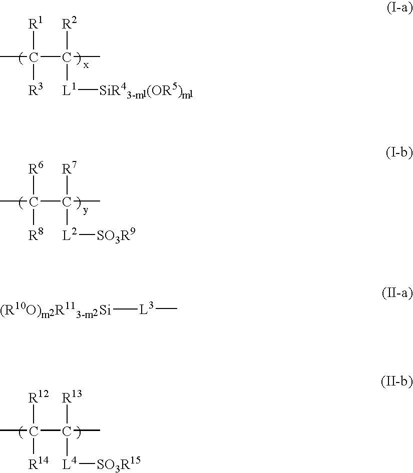

wherein R¹ to R¹⁵ each independently represents a hydrogen atom or a hydrocarbon group having 8 or less carbon atoms,

L¹, L² and L⁴ each independently represents a single bond or a polyvalent organic linking group,

L³ represents a divalent organic linking group,

m¹ and m² each independently represents an integer of from 1 to 3, and x and y each is a number of from 0 to 100 with the proviso that x+y=100.

The principle of the invention may be presumed as follows:

A coating film having a crosslinked structure formed through hydrolysis and polycondensation of a polymer having a silane-coupling group in its side branch and further at the terminal of the main chain thereof, and a metal alkoxide with any of Si, Ti, Zr and Al may form an organic-inorganic hybrid film having a high-density crosslinked structure through hydrolysis and polycondensation with the metal alkoxide, and therefore it may be a high-strength coating film. Concretely, by dissolving the thermally-decomposing polymer (A) in a suitable solvent and stirring it, hydrolysis and polycondensation goes on in the system to give a sol-like coating composition; and by applying it onto a support (substrate) to form a coating film thereon and drying it, an organic-inorganic hybrid coating film is formed, having a crosslinked structure formed through the reaction of the functional group thereof capable of reacting with the specific alkoxide (B). Further, since the composition contains the specific alkoxide (B), the reaction sites to form crosslinks through the hydrolysis and polycondensation of the silane-coupling group and the polymerizing functional group in the hydrolyzable compound in the system may increase, and therefore an organic-inorganic hybrid coating film having a tough crosslinked structure having a higher density may be formed, and accordingly, it may be considered that the formed film may have a further higher strength and may exhibit excellent abrasion resistance.

In the invention, the thermally-decomposing polymer (A) may be thermally decomposed to give a hydrophilic polymer, and according to the above-mentioned method, a hydrophilic member may be produced, having a hydrophilic layer on the surface of a support. Concretely, a sulfonate ester group is selected as the thermally-decomposing group. It is known that a sulfonate ester group thermally decomposes at 100 to 200° C. or so to give a sulfonic acid, and through this phenomenon, the group may exhibit hydrophilicity. More concretely, two methods may be employed for forming a hydrophilic member. One method includes uniformly mixing (A) the thermally-decomposing polymer (the thermally-decomposing polymer (1) or the thermally-decomposing polymer (2)), and (B) the specific alkoxide, and optionally (C) the catalyst in a solvent, and hydrolyzing it to give a sol-like coating composition. The coating composition is applied onto a substrate and heated, thereby converting the thermally-decomposing group into a hydrophilic group. Thus, a hydrophilic layer is formed on the substrate, thereby giving a surface-hydrophilic member.

The other method includes uniformly mixing (A) the thermally-decomposing polymer (the thermally-decomposing polymer (1) or the thermally-decomposing polymer (2)) in a solvent with heating and stirring, thereby converting the thermally-decomposing group into a hydrophilic group. Thus, a solution of (A′) the hydrophilic polymer (the hydrophilic polymer (1) or hydrophilic polymer (2)) is prepared. After left cooled, the remaining specific alkoxide (B) and optionally the catalyst (C) are added to the solution, and hydrolyzed to give a sol-like coating composition. The coating composition is applied onto a substrate, and heated and dried, thereby giving a surface-hydrophilic member having a hydrophilic layer formed on the substrate. It could not be said that either of the two methods is preferable to the other. Selecting the methods in any desired manner, a hydrophilic member may be produced. The hydrophilic member thus produced as in the above may have high strength and high hydrophilicity.

### DETAILED DESCRIPTION OF THE INVENTION

The invention is described in detail hereinafter.

The coating composition of the invention is characterized by containing (A) a thermally-decomposing polymer (1) having a structural unit of the following general formula (I-a) and a structural unit of the following general formula (I-b), or a thermally-decomposing polymer (2) having a structural unit of the following general formula (II-b) and having a functional group of the following general formula (II-a) at the terminal of the polymer chain, and (B) an alkoxide compound of an element selected from Si, Ti, Zr and Al.

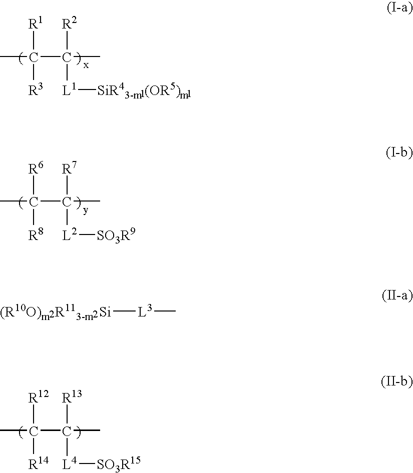

In formulae (I-a), (I-b), (II-a) and (II-b), R¹ to R¹⁵ each independently represent a hydrogen atom or a hydrocarbon group having at most 8 carbon atoms; L¹, L² and L⁴ each independently represent a single bond or a polyvalent organic linking group; L³ represents a divalent organic linking group; m¹ and m² each independently indicate an integer of from 1 to 3; x and y are from 0 to 100 to give a number of x+y=100.

The components contained in the coating composition of the invention are described below

### [(A) Thermally-Decomposing Polymer having Structural Units of Formulae (I-a) and (I-b)]

The thermally-decomposing polymer (1) of (A) usable in the invention has a structural unit of the following general formula (I-a) and a structural unit of the following general formula (I-b).

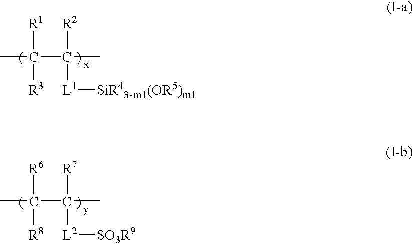

In formulae (I-a) and (I-b), R¹ to R⁹ each independently represent a hydrogen atom or a hydrocarbon group having at most 8 carbon atoms; L¹ and L² each independently represent a single bond or a polyvalent organic linking group; m¹ independently indicates an integer of from 1 to 3; x and y are from 0 to 100 to give a number of x+y=100.

When R¹ to R⁹ represent a hydrocarbon group, the hydrocarbon group includes an alkyl group and an aryl group, and is preferably a linear, branched or cyclic alkyl group having from 1 to 8 carbon atoms. Concretely, it includes a methyl group, an ethyl group, a propyl group, a butyl group, a pentyl group, a hexyl group, a heptyl group, an octyl group, an isopropyl group, an isobutyl group, an s-butyl group, a t-butyl group, an isopentyl group, a neopentyl group, a 1-methylbutyl group, an isohexyl group, a 2-ethylhexyl group, a 2-methylhexyl group, a cyclopentyl group.

The hydrocarbon group may further have a substituent. When the alkyl group has a substituent, the substituted alkyl group is composed of a substituent and an alkylene group bonding together, in which the substituent may be a monovalent non-metallic atomic group except hydrogen. Its preferred examples are a halogen atom (—F, —Br, —Cl, —I), a hydroxyl group, an alkoxy group, an aryloxy group, a mercapto group, an alkylthio group, an arylthio group, an alkyldithio group, an aryldithio group, an amino group, an n-alkylamino group, an N,N-diarylamino group, an N-alkyl-N-arylamino group, an acyloxy group, a carbamoyloxy group, an N-alkylcarbamoyloxy group, an N-arylcarbamoyloxy group, an N,N-dialkylcarbamoyloxy group, an N,N-diarylcarbamoyloxy group, an N-alkyl-N-arylcarbamoyloxy group, an alkylsulfoxy group, an arylsulfoxy group, an acylthio group, an acylamino group, an N-alkylacylamino group, an N-arylacylamino group, an ureido group, an N′-alkylureido group, an N′,N′-dialkylureido group, an N′-arylureido group, an N′,N′-diarylureido group, an N′-alkyl-N′-arylureido group, an N-alkylureido group, an N-arylureido group, an N′-alkyl-N-alkylureido group, an N′-alkyl-N-arylureido group, an N′,N′-dialkyl-N-alkylureido group, an N′,N′-dialkyl-N-arylureido group, an N′-aryl-N-alkylureido group, an N′-aryl-N-arylureido group, an N′,N′-diaryl-N-alkylureido group, an N′,N′-diaryl-N-arylureido group, an N′-alkyl-N′-aryl-N-alkylureido group, an N′-alkyl-N′-aryl-N-arylureido group, an alkoxycarbonylamino group, an aryloxycarbonylamino group, an N-alkyl-N-alkoxycarbonylamino group, an N-alkyl-N-aryloxycarbonylamino group, an N-aryl-N-alkoxycarbonylamino group, an N-aryl-N-aryloxycarbonylamino group, a formyl group, an acyl group, a carboxyl group, an alkoxycarbonyl group, an aryloxycarbonyl group, a carbamoyl group, an N-alkylcarbamoyl group, an N,N-dialkylcarbamoyl group, an N-arylcarbamoyl group, an N,N-diarylcarbamoyl group, an N-alkyl-N-arylcarbamoyl group, an alkylsulfinyl group, an arylsulfinyl group, an alkylsulfonyl group, an arylsulfonyl group, a sulfo group (—SO₃H) and its conjugate base group (hereinafter referred to as a sulfonato group), an alkoxysulfonyl group, an aryloxysulfonyl group, a sulfinamoyl group, an N-alkylsulfinamoyl group, an N,N-dialkylsulfinamoyl group, an N-arylsulfinamoyl group, an N,N-diarylsulfinamoyl group, an N-alkyl-N-arylsulfinamoyl group, a sulfamoyl group, an N-alkylsulfamoyl group, an N,N-dialkylsulfamoyl group, an N-arylsulfamoyl group, an N,N-diarylsulfamoyl group, an N-alkyl-N-arylsulfamoyl group, a phosphono group (—PO₃H₂) and its conjugate base group (hereinafter referred to as a phosphonato group), a dialkylphosphono group (—PO₃(alkyl)₂), a diarylphosphono group (—PO₃(aryl)₂), an alkylarylphosphono group (—PO₃(alkyl)(aryl)), a monoalkylphosphono group (—PO₃H(alkyl)) and its conjugate base group (hereinafter referred to as an alkylphosphonato group), a monoarylphosphono group (—PO₃H(aryl)) and its conjugate base group (hereinafter referred to as an arylphosphonato group), a phosphonoxy group (—OPO₃H₂) and its conjugate base group (hereinafter referred to as a phosphonatoxy group), a dialkylphosphonoxy group (—OPO₃(alkyl)₂), a diarylphosphonoxy group (—OPO3(aryl)₂), an alkylarylphosphonoxy group (—OPO(alkyl)(aryl)), a monoalkylphosphonoxy group (—OPO₃H(alkyl)) and its conjugate base (hereinafter referred to as an alkylphosphonatoxy group), a monoarylphosphonoxy group (—OPO₃H(aryl)) and its conjugate base group (hereinafter referred to as an arylphosphonatoxy group), a morpholino group, a cyano group, a nitro group, an aryl group, an alkenyl group, an alkynyl group.

Examples of the alkyl group in these substituents may be the same as those mentioned hereinabove for R¹ to R⁸; and examples of the aryl group include a phenyl group, a biphenyl group, a naphthyl group, a tolyl group, a xylyl group, a mesityl group, a cumenyl group, a chlorophenyl group, a bromophenyl group, a chloromethylphenyl group, a hydroxyphenyl group, a methoxyphenyl group, an ethoxyphenyl group, a phenoxyphenyl group, an acetoxyphenyl group, a benzoyloxyphenyl group, a methylthiophenyl group, a phenylthiophenyl group, a methylaminophenyl group, a dimethylaminophenyl group, an acetylaminophenyl group, a carboxyphenyl group, a methoxycarbonylphenyl group, an ethoxyphenylcarbonyl group, a phenoxycarbonylphenyl group, an N-phenylcarbamoylphenyl group, a cyanophenyl group, a sulfophenyl group, a sulfonatophenyl group, a phosphonophenyl group, a phosphonatophenyl group. Examples of the alkenyl group include a vinyl group, a 1-propenyl group, a 1-butenyl group, a cinnamyl group, a 2-chloro-1-ethenyl group; and examples of the alkynyl group include an ethynyl group, a 1-propynyl group, a 1-butynyl group, a trimethylsilylethynyl group. G¹ in the acyl group (G¹CO—) includes hydrogen, and the above-mentioned alkyl group and aryl group.

Of those substituents, more preferred are a halogen atom (—F, —Br, —Cl, —I), an alkoxy group, an aryloxy group, an alkylthio group, an arylthio group, an N-alkylamino group, an N,N-dialkylamino group, an acyloxy group, an N-alkylcarbamoyloxy group, an N-arylcarbamoyloxy group, an acylamino group, a formyl group, an acyl group, a carboxyl group, an alkoxycarbonyl group, an aryloxycarbonyl group, a carbamoyl group, an N-alkylcarbamoyl group, an N,N-dialkylcarbamoyl group, an N-arylcarbamoyl group, an N-alkyl-N-arylcarbamoyl group, a sulfo group, a sulfonato group, a sulfamoyl group, an N-alkylsulfamoyl group, an N,N-dialkylsulfamoyl group, an N-arylsulfamoyl group, an N-alkyl-N-arylsulfamoyl group, a phosphono group, a phosphonato group, an dialkylphosphono group, a diarylphosphono group, a monoalkylphosphono group, an alkylphosphonato group, a monoarylphosphono group, an arylphosphonato group, a phosphonoxy group, a phosphonatoxy group, an aryl group, an alkenyl group.

On the other hand, the alkylene group of the substituted alkyl group may be a divalent organic residue derived from the above-mentioned alkyl group having from 1 to 20 carbon atoms, by removing any one hydrogen atom from it. Preferably, it is a linear alkylene group having from 1 to 12 carbon atoms, or a branched alkylene group having from 3 to 12 carbon atoms, or a cyclic alkylene group having from 5 to 10 carbon atoms. Preferred examples of the substituted alkyl group constructed by combining the substituent and the alkylene group are a chloromethyl group, a bromomethyl group, a 2-chloroethyl group, a trifluoromethyl group, a methoxymethyl group, a methoxyethoxyethyl group, an allyloxymethyl group, a phenoxymethyl group, a methylthiomethyl group, a tolylthiomethyl group, an ethylaminoethyl group, a diethylaminoproyl group, a morpholinopropyl group, an acetyloxymethyl group, a benzoyloxymethyl group, an N-cyclohexylcarbamoyloxyethyl group, an N-phenylcarbamoyloxyethyl group, an acetylaminoethyl group, an N-methylbenzoylaminopropyl group, a 2-hydroxyethyl group, a 2-hydroxypropyl group, a carboxypropyl group, a methoxycarbonylethyl group, an allyloxycarbonylbutyl group, a chlorophenoxycarbonylmethyl group, a carbamoylmethyl group, an N-methylcarbamoylethyl group, an N,N-dipropylcarbamoylmethyl group, an N-(methoxyphenyl)carbamoylethyl group, an N-methyl-N-(sulfophenyl)carbamoylmethyl group, a sulfobutyl group, a sulfonatobutyl group, a sulfamoylbutyl group, an N-ethylsulfamoylmethyl group, an N,N-dipropylsulfamoylpropyl group, an N-tolylsulfamoylpropyl group, an N-methyl-N-(phosphonophenyl)sulfamoyloctyl group, a phosphonobutyl group, a phosphonatohexyl group, a diethylphosphonobutyl group, a diphenylphosphonopropyl group, a methylphosphonobutyl group, a methylphosphonatobutyl group, a tolylphosphonohexyl group, a tolylphosphonatohexyl group, a phosphonoxypropyl group, a phosphonatoxybutyl group, a benzyl group, a phenethyl group, an α-methylbenzyl group, a 1-methyl-1-phenylethyl group, a p-methylbenzyl group, a cinnamyl group, an allyl group, a 1-propenylmethyl group, a 2-butenyl group, a 2-methylallyl group, a 2-methylpropenylmethyl group, a 2-propynyl group, a 2-butynyl group, a 3-butynyl group.

R¹ to R⁸ are preferably a hydrogen atom, a methyl group or an ethyl group from the viewpoint of the effect and the easy availability of the polymer.

Of the above, R⁹ is especially preferably an aryl group substituted with an electron-attracting group such as halogen, cyano or nitro, an alkyl group substituted with an electron-attracting group such as halogen, cyano or nitro, or a secondary or tertiary branched alkyl group, a cyclic alkyl group or a cyclic imide.

Of the above, more preferred are those in which the carbon atom bonding to the S atom is a secondary carbon or a tertiary carbon, and even more preferred are those where it is a secondary carbon, from the viewpoint of the temperature condition in thermal decomposition thereof.

L¹ and L² represent a single bond or a polyvalent organic linking group. The single bond means that the polymer main chain directly bonds to the Si atom or the S atom with no linking group therebetween. The organic linking group is a linking group comprising nonmetallic atoms. Concretely, it may comprise from 0 to 200 carbon atoms, from 0 to 150 nitrogen atoms, from 0 to 200 oxygen atoms, from 0 to 400 hydrogen atoms, and from 0 to 100 sulfur atoms. More concrete examples of the linking group are the following structural units and their combinations.

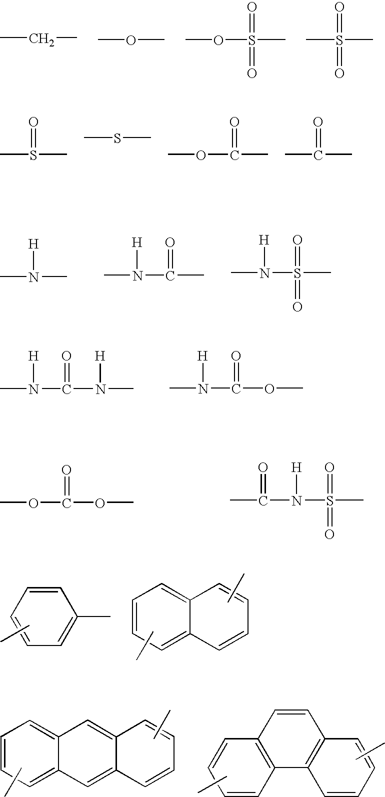

L¹ may be formed of a polymer or an oligomer. Concretely, it preferably includes polyacrylate, polymethacrylate, polyacrylonitrile, polyvinyl, polystyrene or the like of an unsaturated double bond-type monomer. Its other preferred examples are poly(oxyalkylene), polyurethane, polyurea, polyester, polyamide, polyimide, polycarbonate, polyamic acid, polysiloxane. More preferred are polyacrylate, polymethacrylate, polyacrylonitrile, polyvinyl, polystyrene; and even more polyacrylate, polymethacrylate.

The polymer and the oligomer may comprise one or more different types of structural units. In case where L¹ is a polymer or oligomer, the number of the elements constituting it is not specifically limited. Its molecular weight is preferably from 1,000 to 1,000,000, more preferably from 1,000 to 500,000, most preferably from 1,000 to 200,000.

x and y indicate the polymerization ratio by mol of the structural unit of formula (I-a) and the structural unit of formula (I-b) in the thermally-decomposing polymer (1) of (A). x and y are from 0 to 100 to give a number of x+y=100. The polymerization molar ratio x/y is preferably within a range of from 99/1 to 10/90, more preferably within a range of from 99/1 to 50/50.

All the structural units (I-a) and (I-b) that constitute the polymer chain may be the same, or they may contain plural different structural units. In these cases, it is desirable that the polymerization molar ratio of the structural unit corresponding to formula (I-a) and the structural unit corresponding to formula (I-b) falls within the above range.

The thermally-decomposing polymer (2) of (A) in the invention has a partial structure, which has a crosslinkable partial structure of the following general formula (II-a), bonding to the terminal of the polymer chain that contains a structural unit of the following general formula (II-b). The crosslinkable partial structure forms a crosslinked structure through hydrolysis and polycondensation with a metal alkoxide.

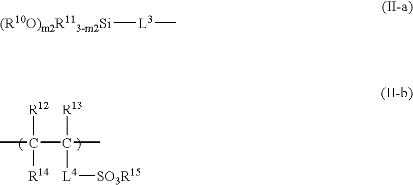

In formulae (II-a) and (II-b), R¹⁰ to R¹⁵ each independently represent a hydrogen atom or a hydrocarbon group having at most 8 carbon atoms; L³ represents a divalent organic linking group; L⁴ each independently represents a single bond or a polyvalent organic linking group; m² each independently indicates an integer of from 1 to 3.

The hydrocarbon group for R¹⁰ to R¹⁵ in the above formula (II-b) includes an alkyl group and an aryl group, and is preferably a linear, branched or cyclic alkyl group having from 1 to 8 carbon atoms.

Concretely, it includes a methyl group, an ethyl group, a propyl group, a butyl group, a pentyl group, a hexyl group, a heptyl group, an octyl group, an isopropyl group, an isobutyl group, an s-butyl group, a t-butyl group, an isopentyl group, a neopentyl group, a 1-methylbutyl group, an isohexyl group, a 2-ethylhexyl group, a 2-methylhexyl group, a cyclopentyl group.

R¹⁰ to R¹⁵ may further have a substituent, and the substituent that may be introduced into them includes those described hereinabove as the substituent that may be introduced into the alkyl group for R¹ to R⁹.

R¹⁰ to R¹⁴ are preferably a hydrogen atom, a methyl group or an ethyl group from the viewpoint of the effect and the easy availability of the polymer.

Of the above, R¹⁵ is especially preferably an aryl group substituted with an electron-attracting group such as halogen, cyano or nitro, an alkyl group substituted with an electron-attracting group such as halogen, cyano or nitro, or a secondary or tertiary branched alkyl group, a cyclic alkyl group or a cyclic imide.

Of the above, more preferred are those in which the carbon atom bonding to the S atom is a secondary carbon or a tertiary carbon, even more preferably a secondary carbon, from the viewpoint of the temperature condition in thermal decomposition thereof.

L³ represents a divalent organic linking group, and L⁴ represents a single bond or a polyvalent organic linking group. The single bond means that the polymer main chain directly bonds to the Si atom or the S atom with no linking group therebetween. The organic linking group is a linking group comprising nonmetallic atoms. Concretely, it may comprise from 0 to 200 carbon atoms, from 0 to 150 nitrogen atoms, from 0 to 200 oxygen atoms, from 0 to 400 hydrogen atoms, and from 0 to 100 sulfur atoms. More concrete examples of the linking group may be the same as those mentioned hereinabove for the introducible structural unit for L¹ and L².

The molecular weight of the thermally-decomposing polymer (A) is preferably from 1,000 to 1,000,000, more preferably from 1,000 to 500,000, most preferably from 1,000 to 200,000.

For describing preferred thermally-decomposing polymers favorably usable in the invention, examples of the thermally-decomposing polymer (1) of (A), having a structural unit of the following formula (I-a) and a structural unit of the following formula (I-b), [Compounds (I-1) to (I-30)] are shown below along with their mass-average molecular weight (M. W.), to which, however, the invention should not be limited. The polymers of the following examples are random copolymers that contain the structural units shown below, in the molar ratio shown below.

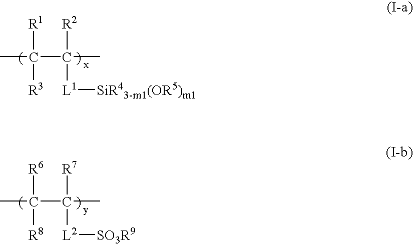

In formulae (I-a) and (I-b), R¹ to R⁹ each independently represent a hydrogen atom or a hydrocarbon group having at most 8 carbon atoms; L¹ and L² each independently represent a single bond or a polyvalent organic linking group; m¹ each independently indicates an integer of from 1 to 3; x and y are from 0 to 100 to give a number of x+y=100.

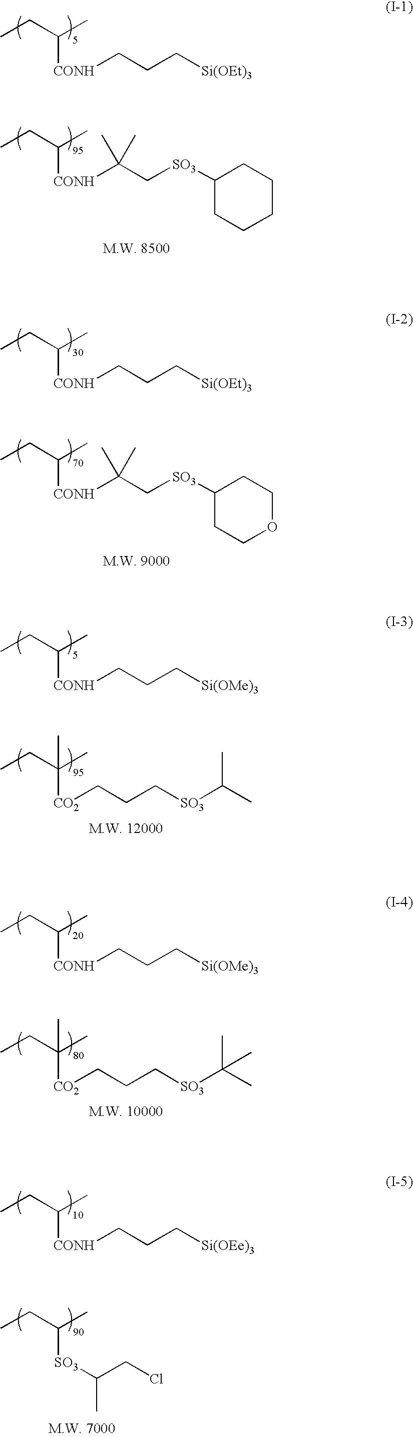

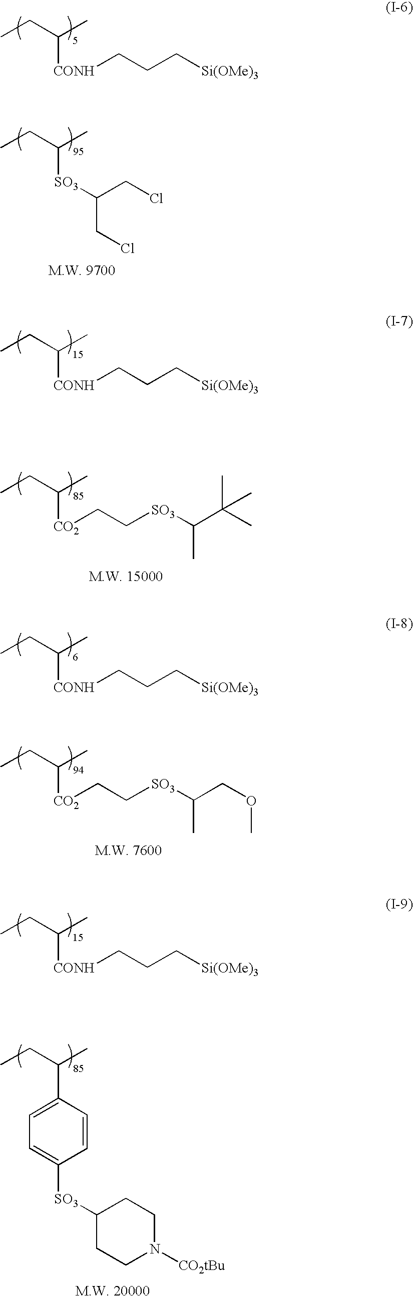

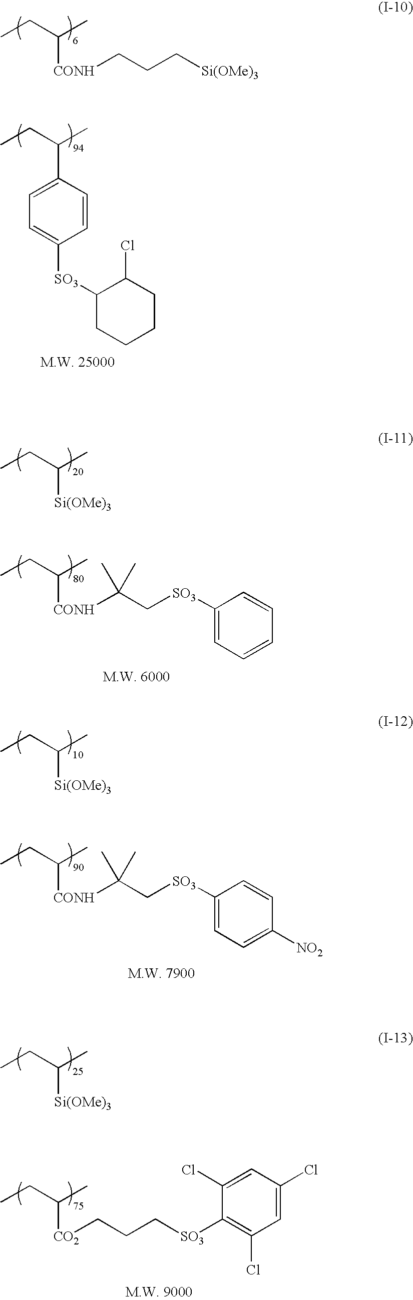

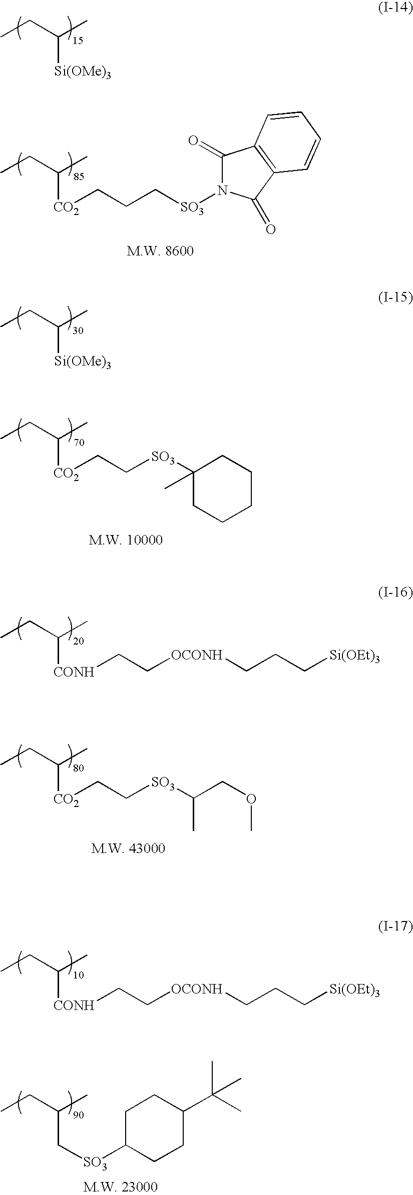

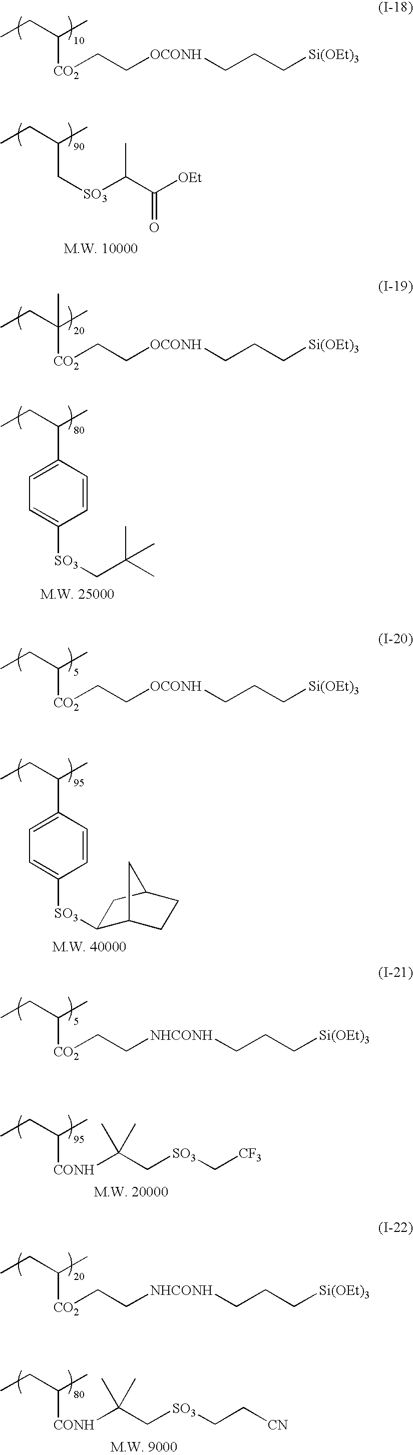

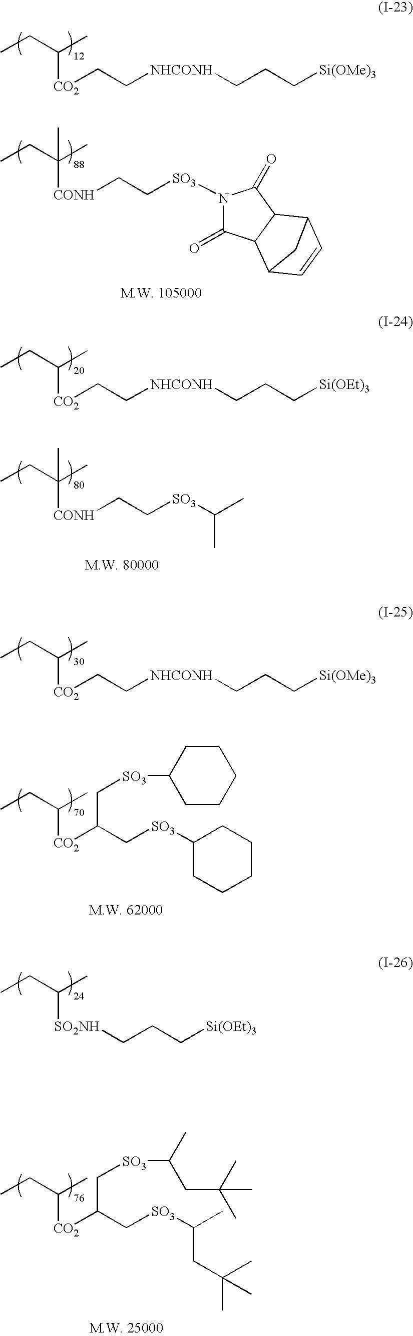

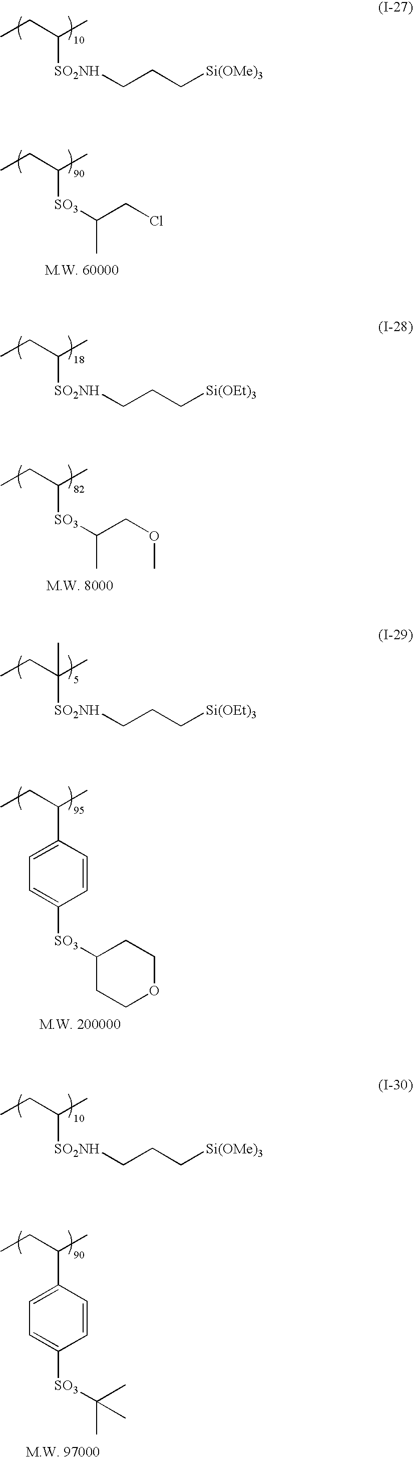

Of preferred thermally-decomposing polymers favorably usable in the invention, examples of the thermally-decomposing polymer (2) of (A), having a crosslinkable group of the following formula (II-a) at the terminal of the polymer chain thereof having a structural formula of the following formula (II-b), [Compounds (II-1) to (II-30)] are shown below along with their mass-average molecular weight (M. W.), to which, however, the invention should not be limited.

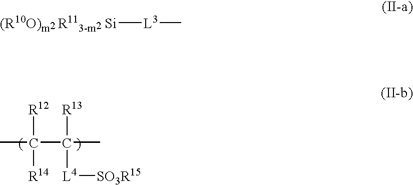

In formulae (II-a) and (II-b), R¹⁰ to R¹⁵ each independently represent a hydrogen atom or a hydrocarbon group having at most 8 carbon atoms; L³ represents a divalent organic linking group; L⁴ represents a single bond or a polyvalent organic linking group; m² each independently indicates an integer of from 1 to 3.

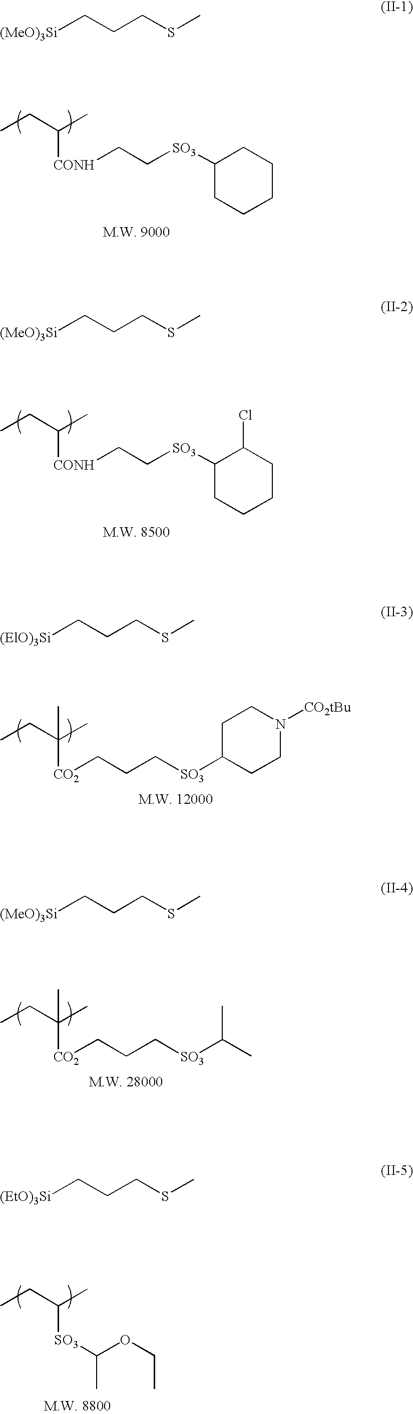

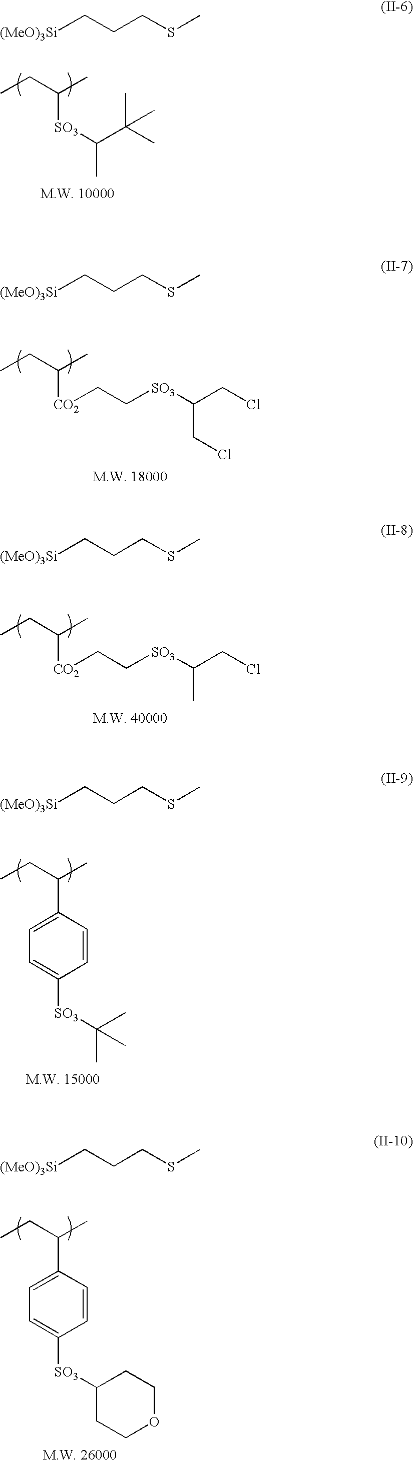

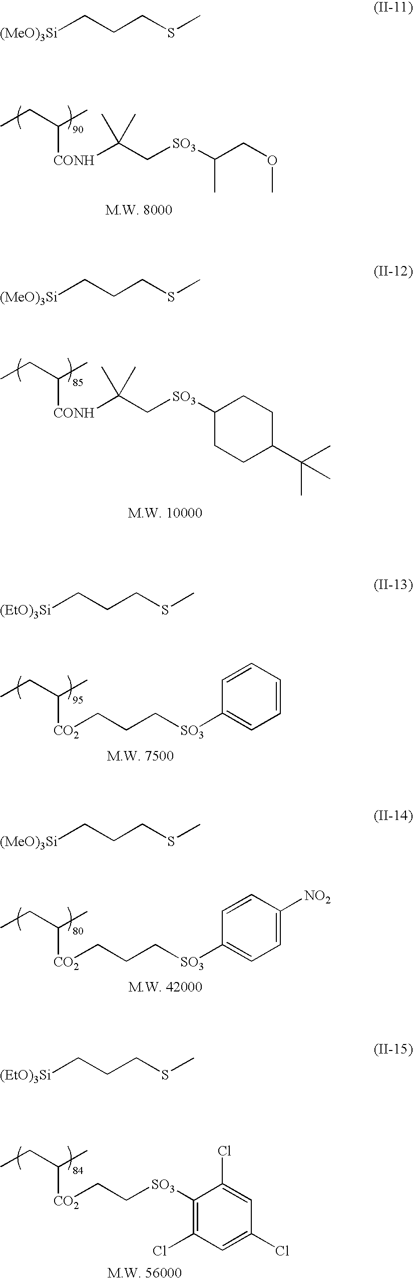

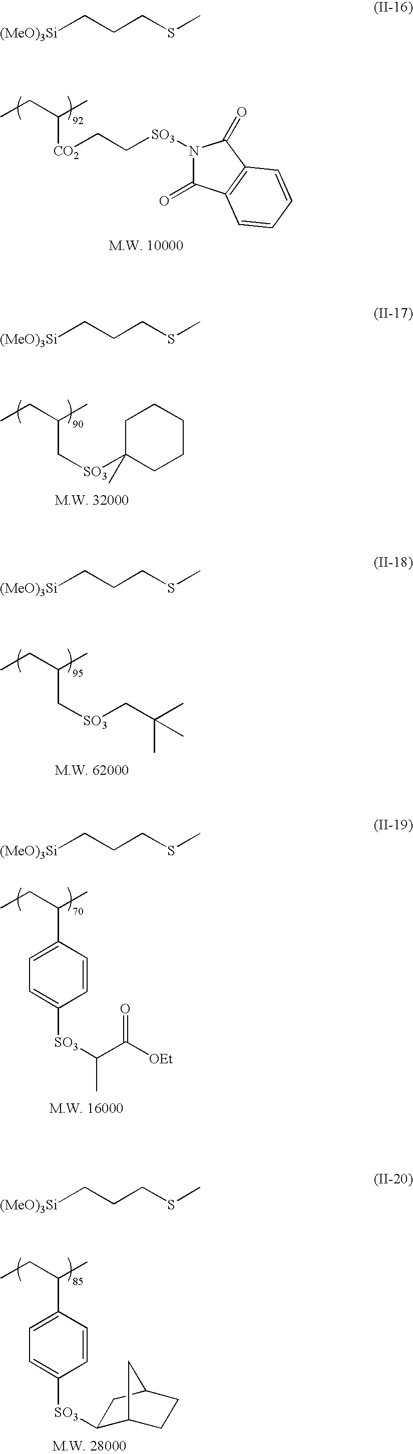

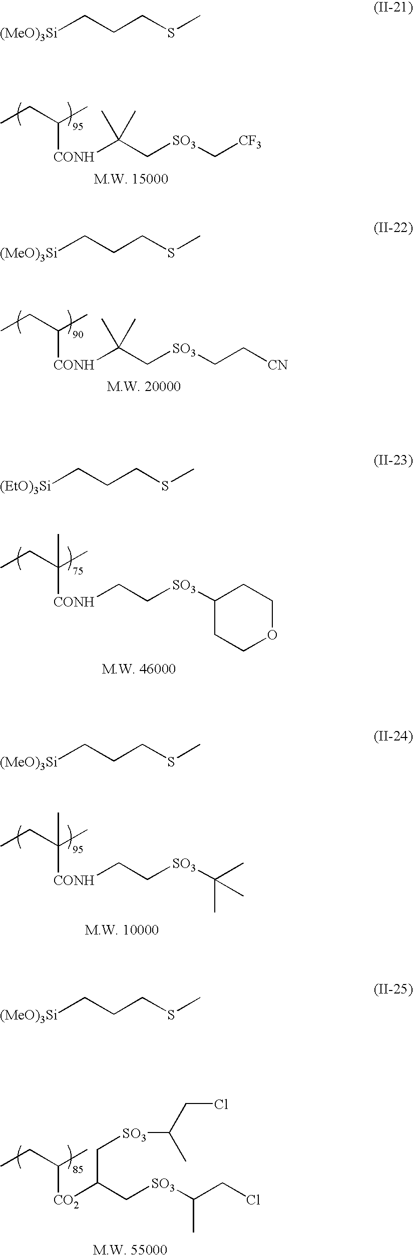

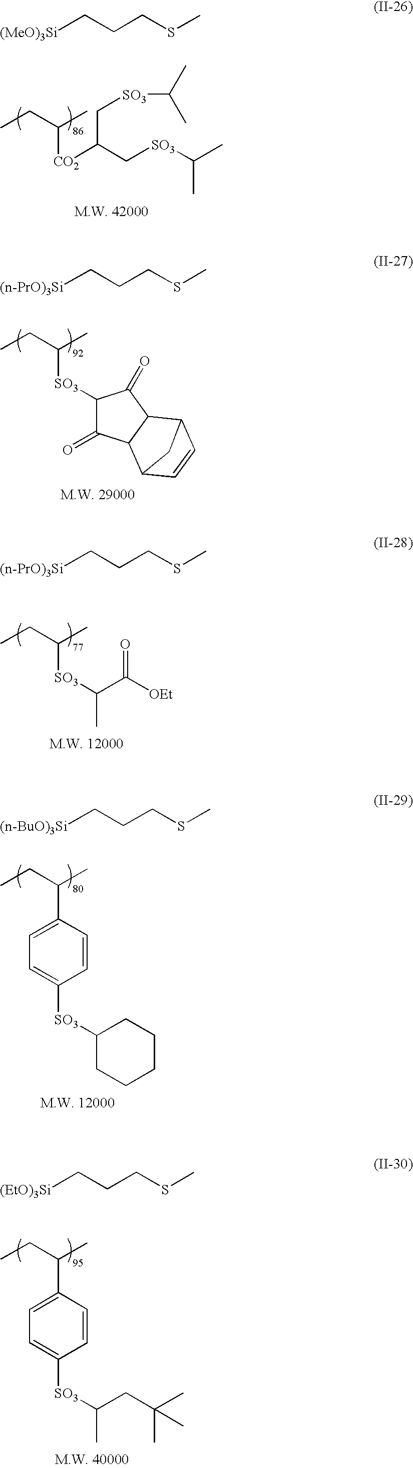

The above-mentioned compounds for producing the thermally-decomposing polymer (A) in the invention are commercially available, or may be readily produced. Regarding the polymerization method for the thermally-polymerizing polymer (1) of (A), the polymer may be obtained through radical polymerization of radical-polymerizable monomers represented by the following structural units (I-a) and (I-b). On the other hand, regarding the polymerization method for the thermally-polymerizing polymer (2) of (A), the polymer may be obtained through radical polymerization of a radical-polymerizable monomer represented by the following structural unit (II-b) with a compound having a chain transfer capability in radical polymerization and represented by the following structural formula (II-a) or a radical initiator. Specifically, in the latter, the compound having a crosslinkable partial structure has a chain transfer capability or a radical initiation capability, and therefore a polymer such as the thermally-decomposing polymer (2) may be produced, into which a crosslinkable partial structure is introduced into the terminal of the polymer chain through radical polymerization. The reaction mode is not specifically defined. For example, in the presence of a radical polymerization initiator or under irradiation with a high-pressure mercury lamp, bulk reaction, solution reaction or suspension reaction may be effected for it. Concretely, general radical polymerization methods are described, for example, in New Polymer Experimental Science 3, Polymer Synthesis and Reaction 1 (edited by the Polymer Society of Japan, Kyoritsu Publishing), Lecture of New Experimental Chemistry 19, Polymer Chemistry (I) (edited by the Chemical Society of Japan, Maruzen), Lecture of Substance Engineering, Polymer Synthesis Chemistry (Tokyo Denki University Press), and these may apply to the invention.

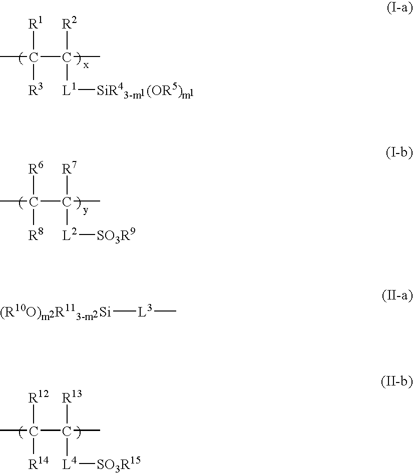

In formulae (I-a), (I-b), (II-a) and (II-b), R¹ to R¹⁵ each independently represent a hydrogen atom or a hydrocarbon group having at most 8 carbon atoms; L¹, L² and L⁴ each independently represent a single bond or a polyvalent organic linking group; L³ represents a divalent organic linking group; m¹ and m² each independently indicate an integer of from 1 to 3; x and y are from 0 to 100 to give a number of x+y=100.

The above thermally-decomposing polymer may also be a copolymer with any other monomer, as described below. The other usable monomer may be any known monomer including, for example, acrylates, methacrylates, acrylamides, methacrylamides, vinyl esters, styrenes, acrylic acid, methacrylic acid, acrylonitrile, maleic acid, maleimide. Copolymerization with such monomer may improve various physical properties of the composition, such as the film formability, the film strength, the hydrophilicity, the hydrophobicity, the solubility, the reactivity and the stability thereof.

Examples of the acrylates are methyl acrylate, ethyl acrylate, (n- or i-)propyl acrylate, (n-, i-, sec- or t-)butyl acrylate, amyl acrylate, 2-ethylhexyl acrylate, dodecyl acrylate, chloroethyl acrylate, 2-hydroxyethyl acrylate, 2-hydroxypropyl acrylate, 2-hydroxypentyl acrylate, cyclohexyl acrylate, allyl acrylate, trimethylolpropane monoacrylate, pentaerythritol monoacrylate, benzyl acrylate, methoxybenzyl acrylate, chlorobenzyl acrylate, hydroxybenzyl acrylate, hydroxyphenethyl acrylate, dihydroxyphenethyl acrylate, furfuryl acrylate, tetrahydrofurfuryl acrylate, phenyl acrylate, hydroxyphenyl acrylate, chlorophenyl acrylate, sulfamoylphenyl acrylate, 2-(hydroxyphenylcarbonyloxy)ethyl acrylate.

Examples of the methacrylates are methyl methacrylate, ethyl methacrylate, (n- or i-)propyl methacrylate, (n-, i-, see- or t-)butyl methacrylate, amyl methacrylate, 2-ethylhexyl methacrylate, dodecyl methacrylate, chloroethyl methacrylate, 2-hydroxyethyl methacrylate, 2-hydroxypropyl methacrylate, 2-hydroxypentyl methacrylate, cyclohexyl methacrylate, allyl methacrylate, trimethylolpropane monomethacrylate, pentaerythritol monomethacrylate, benzyl methacrylate, methoxybenzyl methacrylate, chlorobenzyl methacrylate, hydroxybenzyl methacrylate, hydroxyphenethyl methacrylate, dihydroxyphenethyl methacrylate, furfuryl methacrylate, tetrahydrofurfuryl methacrylate, phenyl methacrylate, hydroxyphenyl methacrylate, chlorophenyl methacrylate, sulfamoylphenyl methacrylate, 2-(hydroxyphenylcarbonyloxy)ethyl methacrylate.

Examples of the acrylamides are acrylamide, N-methylacrylamide, N-ethylacrylamide, N-propylacrylamide, N-butylacrylamide, N-benzylacrylamide, N-hydroxyethylacrylamide, N-phenylacrylamide, N-tolylacrylamide, N-(hydroxyphenyl)acrylamide, N-(sulfamoylphenyl)acrylamide, N-(phenylsulfonyl)acrylamide, N-(tolylsulfonyl)acrylamide, N,N-dimethylacrylamide, N-methyl-N-phenylacrylamide, N-hydroxyethyl-N-methylacrylamide.

Examples of methacrylamides are methacrylamide, N-methylmethacrylamide, N-ethylmethacrylamide, N-propylmethacrylamide, N-butylmethacrylamide, N-benzylmethacrylamide, N-hydroxyethylmethacrylamide, N-phenylmethacrylamide, N-tolylmethacrylamide, N-(hydroxyphenyl)methacrylamide, N-(sulfamoylphenyl)methacrylamide, N-(phenylsulfonyl)methacrylamide, N-(tolylsulfonyl)methacrylamide, N,N-dimethylmethaerylamide, N-methyl-N-phenylmethacrylamide, N-hydroxyethyl-N-methylmethacrylamide.

Examples of the vinyl esters are vinyl acetate, vinyl butyrate, vinyl benzoate.

Examples of the styrenes are styrene, methylstyrene, dimethylstyrene, trimethylstyrene, ethylstyrene, propylstyrene, cyclohexylstyrene, chloromethylstyrene, trifluoromethylstyrene, ethoxymethylstyrene, acetoxymethylstyrene, methoxystyrene, dimethoxystyrene, chlorostyrene, dichlorostyrene, bromostyrene, iodostyrene, fluorostyrene, carboxystyrene.

The proportion of the other monomer to be used in producing the copolymer must be a sufficient amount enough to improve the physical properties of the copolymer. Preferably, however, the proportion is not so large in order that the hydrophilic film formed through thermal decomposition may have a sufficient function and it may sufficiently enjoy the advantage of adding the thermally-decomposing polymer (A) to the film composition. Accordingly, the overall proportion of the other monomer to the thermally-decomposing polymer (A) is preferably at most 80% by mass, more preferably at most 50% by mass.

In the invention, the thermally-decomposing polymer (A) may be in the coating composition in an amount falling within a range of from 5 to 95% by mass relative to the nonvolatile component therein, more preferably from 15 to 90% by mass, most preferably from 20 to 85% by mass, from the viewpoint of the curability and the hydrophilicity of the composition. One or more such polymers may be used herein either singly or as combined. The nonvolatile component as referred to herein is meant to indicate the component except the volatile solvent in the composition.

### [(B) Alkoxide Compound of Element Selected from Si, Ti, Zr, Al]

The specific alkoxide (B) for use in the invention, or that is, an alkoxide compound of an element selected from Si, Ti, Zr and Al is a hydrolyzing polymerizing compound having a polymerizing functional group in its structure and serving as a crosslinking agent. Through polycondensation with the thermally-decomposing polymer (A), this form a strong coating film having a crosslinked structure.

The specific alkoxide (B) is preferably a compound of the following general formula (II). For forming a crosslinked structure to cure the hydrophilic film formed, the specific alkoxide (B) of formula (III) is mixed with the above thermally-decomposing polymer (A), and the resulting mixture is applied onto the surface of a support, and heated and dried thereon.

(R¹⁶)ₖ—Y—(OR¹⁷)₄₋ₖ (III)

In formula (III), R¹⁶ represents a hydrogen atom, an alkyl group or an aryl group; R¹⁷ represents an alkyl group or an aryl group; Y represents Si, Al, Ti or Zr; k indicates an integer of from 0 to 2. The alkyl group for R¹⁶ and R¹⁷ preferably has from 1 to 4 carbon atoms. The alkyl group and the aryl group may have a substituent. The substituent capable of being introduced into them includes a halogen atom, an amino group, a mercapto group. The compound is a low-molecular compound, and preferably has a molecular weight of at most 1000.

Examples of the specific alkoxide (B) of formula (III) are mentioned below, to which, however, the invention should not be limited. Those where Y is Si, or that is, the specific alkoxides containing silicon include, for example, trimethoxysilane, triethoxysilane, tripropoxysilane, tetramethoxysilane, tetraethoxysilane, tetrapropoxysilane, methyltrimethoxysilane, ethyltrimethoxysilane, propyltrimethoxysilane, methyltriethoxysilane, ethyltriethoxysilane, propyltriethoxysilane, dimethyldimethoxysilane, diethyldiethoxysilane, γ-chloropropyltriethoxysilane, γ-mercaptopropyltrimethoxysilane, γ-mereaptopropyltriethoxysilane, γ-aminopropyltriethoxysilane, phenyltrimethoxysilane, phenyltriethoxysilane, phenyltripropoxysilane, diphenyldimethoxysilane, diphenyldiethoxysilane. Of those, especially preferred are tetramethoxysilane, tetraethoxysilane, methyltrimethoxysilane, ethyltrimethoxysilane, methyltriethoxysilane, ethyltriethoxysilane, dimethyldiethoxysilane, phenyltrimethoxysilane, phenyltriethoxysilane, diphenyldimethoxysilane, diphenyldiethoxysilane.

Those where Y is Al, or that is, the specific alkoxides containing aluminium include, for example, trimethoxyaluminate, triethoxyaluminate, tripropoxyaluminate, tetraethoxyaluminate.

Those where Y is Ti, or that is, the specific alkoxides containing titanium include, for example, trimethoxytitanate, tetramethoxytitanate, triethoxytitanate, tetraethoxytitanate, tetrapropoxytitanate, chlorotrimethoxytitanate, chlorotriethoxytitanate, ethyltrimethoxytitanate, methyltriethoxytitanate, ethyltriethoxytitanate, diethyldiethoxytitanate, phenyltrimethoxytitanate, phenyltriethoxytitanate.

Those where Y is Zr, or that is, the specific alkoxides containing zirconium include, for example zirconates that correspond to the compounds exemplified hereinabove for those containing titanium.

Of the above, preferred are alkoxides where Y is Si from the viewpoint of the film forming capability of the composition.

One or more of the specific alkoxides (B) may be used in the invention, either singly or as combined.

The specific alkoxide (B) may be in the coating composition of the invention preferably in an amount falling within a range of from 5 to 80% by mass relative to the nonvolatile component therein, more preferably within a range of from 10 to 70% by mass.

The specific alkoxide is commercially available, or may be produced in a known production method, for example, by reacting a metal chloride with an alcohol.

### [Catalyst (C)]

In the coating composition of the invention, the thermally-decomposing polymer (A) and the crosslinking component such as the specific alkoxide (B) are dissolved and well stirred in a solvent, in which these components are hydrolyzed and polycondensed to form an organic-inorganic hybrid sol liquid, and the sol liquid has good coatability and may form a hydrophilic film having a high film strength. In preparing the organic-inorganic hybrid sol liquid, it is desirable to add an acid catalyst or basic catalyst to the composition for promoting the hydrolysis and polycondensation. In order to attain a practically favorable reaction efficiency, it is desirable to add the catalyst (C) to the composition.

For the catalyst (C) for use in the invention, selected is a catalyst capable of promoting the reaction of hydrolysis and polycondensation of the above alkoxide compound (B) to induce the bonding thereof to the thermally-decomposing polymer (A). For it, for example, an acid or a basic compound may be used directly as it is, or a solution prepared by dissolving an acid or a basic compound in a solvent such as water or alcohol (hereinafter this may be generically referred to as an acid catalyst and a basic catalyst) may be used. The concentration of the acid or the basic compound to be dissolved in a solvent is not specifically defined, and may be suitably determined depending on the characteristics of the acid or the basic compound used and on the desired content of the catalyst. In case where the concentration of the acid or the basic compound that constitutes the catalyst is high, the hydrolysis and polycondensation speed may be high. However, when a basic catalyst having a high concentration is sued, then a deposit may form in the sol liquid. Therefore, in case where a basic catalyst is used, its concentration is preferably at most 1 N in terms of the concentration thereof in its aqueous solution.

The type of the acid catalyst and the basic catalyst is not specifically defined. When a catalyst having a high concentration must be used, then the catalyst is preferably composed of elements that remain little in the coating film after dried. Concretely, the acid catalyst includes hydrogen halides such as hydrochloric acid; nitric acid, sulfuric acid, sulfurous acid, hydrogen sulfide, perchloric acid, hydrogen peroxide, carbonic acid; carboxylic acids such as formic acid, acetic acid, substituted carboxylic acids of a structural formula RCOOH in which R is substituted with any other element or substituent; and sulfonic acids such as benzenesulfonic acid. The basic catalyst includes ammoniac bases such as aqueous ammonia; and amines such as ethylamine and aniline.

A Lewis acid catalyst of a metal complex is also preferably used herein. Especially preferred is a metal complex catalyst that comprises a metal element selected from the Groups 2A, 3B, 4A and 5A of the Periodic Table, and an oxo or hydroxy oxygen-containing compound selected from β-diketones, ketoesters, hydroxycarboxylic acids and their esters, aminoalcohols and enol-type active hydrogen compounds.

As the constitutive metal element, preferred are elements of Group 2A such as Mg, Ca, St, Ba; elements of Group 3B such as Al, Ga; elements of Group 4A such as Ti, Zr; and elements of Group 5A such as V, Nb, Ta. The metal element of the type may form a complex having an excellent catalytic effect. Of those, more preferred are complexes with Zr, Al or Ti, as they are excellent.

The oxo or hydroxy oxygen-containing compound that constitutes the ligand of the above metal complex usable in the invention includes β-diketones such as acetylacetone (2,4-pentanedione), 2,4-heptanedione; ketoesters such as methyl acetacetate, ethyl acetacetate, butyl acetacetate; hydroxycarboxylic acids and their esters such as lactic acid, methyl lactate, salicylic acid, ethyl salicylate, phenyl salicylate, malic acid, tartaric acid, methyl tartrate; ketoalcohols such as 4-hydroxy-4-methyl-2-pentanone, 4-hydroxy-2-pentanone, 4-hydroxy-4-methyl-2-heptanone, 4-hydroxy-2-heptanone; aminoalcohols such as monoethanolamine, N,N-dimethylethanolamine, N-methyl-monoethanolamine, diethanolamine, triethanolamine; enol-type active compounds such as methylolmelamine, methylolurea, methylotacrylamide, diethyl malonate; and compounds derived from acetylacetone (2,4-pentanedione) by introducing a substituent into the methyl group, the methylene group or the carbonyl carbon thereof.

Acetylacetone derivatives are preferred for the ligand. In the invention, acetylacetone derivatives are meant to indicate compounds derived from acetylacetone by introducing a substituent into the methyl group, the methylene group or the carbonyl carbon thereof. The substituent capable of being introduced into the methyl group of acetylacetone includes an alkyl group, an acyl group, a hydroxyalkyl group, a carboxyalkyl group, an alkoxy group and an alkoxyalkyl group, which may be linear or branched and have from 1 to 3 carbon atoms. The substituent capable of being introduced into the methylene group of acetylacetone includes a carboxyl group, and a carboxyalkyl group and a hydroxyalkyl group which may be linear or branched and have from 1 to 3 carbon atoms. The substituent capable of being introduced into the carbonyl carbon of acetylacetone may be an alkyl group having from 1 to 3 carbon atoms, and in this case, a hydrogen atom may be added to the carbonyl oxygen to form a hydroxyl group.

Preferred examples of the acetylacetone derivative are ethylcarbonylacetone, n-propylcarbonylacetone, i-propylcarbonylacetone, diacetylacetone, 1-acetyl-1-propionyl-acetylacetone, hydroxyethylcarbonylacetone, hydroxypropylcarbonylacetone, acetacetic acid, acetopropionic acid, diacetacetic acid, 3,3-diacetopropionic acid, 4,4-diacetobutyric acid, carboxyethylcarbonylacetone, carboxypropylcarbonylacetone, diacetonalcohol. Of those, especially preferred are acetylacetone and diacetylacetone. The complex of the above acetylacetone derivative and the above metal element is a mononuclear complex having from 1 to 4 molecular ligands of the acetylacetone derivative per one metal element therein. In case where the number of the coordinable chemical bonds of the metal element is larger than the total number of the coordinable chemical bonds of the acetylacetone derivative, then any ordinary ligand generally used in ordinary complexes, such as water molecule, halide ion, nitro group or ammonio group, may be coordinated in the complex.

Preferred examples of the metal complex are tris(acetylacetonato)aluminium complex, di(acetylacetonato)aluminium/aquo-complex, mono(acetylacetonato)aluminium/chloro complex, di(diacetylacetonato)aluminium complex, ethylacetacetate aluminium diisopropylate, aluminium tris(ethylacetacetate), cyclic aluminium oxide isopropylate, tris(acetylacetonato)barium complex, di(acetylacetonato)titanium complex, tris(acetylacetonato)titanium complex, di-i-propoxy/bis(acetylacetonato)titanium complex, zirconium tris(ethylacetacetate), zirconium tris(benzoic acid) complex. These have excellent stability in water-base coating liquids and have an excellent gellation-promoting effect in sol-gel reaction in heating and drying. Of those, especially preferred are ethylacetacetate aluminium diisopropylate, aluminium tris(ethylacetacetate), di(acetylacetonato)titanium complex, zirconium tris(ethylacetacetate).

Description of the counter salt of the above-mentioned metal complex is omitted in this specification. Regarding its type, the counter salt may be any water-soluble salt capable of keeping the charge of the complex compound neutral. For example, it includes nitrates, hydrohalides, sulfates, phosphates and the like capable of securing stoichiometric neutrality of the complex.

The behavior of the metal complex in silica sol-gel reaction is described in detail in J. Sol-Gel, Sci. and Tec., 16, 209 (1999). For its reaction mechanism, the following scheme may be presumed. Specifically, in a coating liquid, the metal complex is stable, as having a coordination structure. In the dehydrating condensation reaction that starts in the heating and drying step after coating, the metal complex may promote crosslinking, like an acid catalyst. Anyhow, when the metal complex is used, then the time-dependent stability of the coating liquid and the film surface quality are improved, and the formed film satisfies both high hydrophilicity and high durability.

The catalyst (C) may be in the coating composition of the invention preferably in an amount falling within a range of from 0 to 50% by mass relative to the nonvolatile component therein, more preferably within a range of from 5 to 25% by mass. One or more different types of the catalyst (C) may be in the composition, either singly or as combined.

In addition to the above-mentioned indispensable ingredients, thermally-decomposing polymer (A) and specific alkoxide (B) and the optional catalyst (C) that may be therein, the coating composition of the invention may further contain any other various compounds in accordance with its object, not detracting from the effect of the invention. The additional ingredients are described below.

### [Surfactant]

In the invention, a surfactant is preferably used for improving the quality of the film of the coating composition. The surfactant includes nonionic surfactants, anionic surfactants, cationic surfactants, ampholytic surfactants and fluorine-containing surfactants.

Not specifically defined, the nonionic surfactants usable in the invention may be any known ones. For example, they include polyoxyethylene alkyl ethers, polyoxyethylene alkylphenyl ethers, polyoxyethylene polystyrylphenyl ethers, polyoxyethylene polyoxypropylene alkyl ethers, glycerin fatty acid partial esters, sorbitan fatty acid partial esters, pentaerythritol fatty acid partial esters, propylene glycol monofatty acid esters, sucrose fatty acid partial esters, polyoxyethylene sorbitan fatty acid partial esters, polyoxyethylene sorbitol fatty acid partial esters, polyethylene glycol fatty acid esters, polyglycerin fatty acid partial esters, polyoxyethylenated castor oils, polyoxyethylene glycerin fatty acid partial esters, fatty acid diethanolamides, N,N-bis-2-hydroxyalkylamines, polyoxyethylene-alkylamines, triethanolamine fatty acid esters, trialkylamine oxides, polyethylene glycols, polyethylene glycol/polypropylene glycol copolymers.

Not specifically defined, the anionic surfactants usable in the invention may be any known ones. For example, they include fatty acid salts, abietic acid salts, hydroxyalkanesulfonic acid salts, alkanesulfonic acid salts, dialkylsulfosuccinate salts, linear alkylbenzenesulfonic acid salts, branched chain alkylbenzenesulfonic acid salts, alkylnaphthalenesulfonic acid salts, alkylphenoxypolyoxyethylene-propylsulfonic acid salts, polyoxyethylene-alkylsulfophenyl ether salts N-methyl-N-oleyltaurine sodium salts, N-alkylsulfosuccinic acid monoamide disodium salts, petroleum-sulfonic acid salts, sulfated beef tallow oils, sulfate salts of fatty acid alkyl esters, alkylsulfate salts, polyoxyethylene alkylether sulfate salts, fatty acid monoglyceride sulfate salts, polyoxyethylene alkylphenyl ether sulfate salts, polyoxyethylene styrylphenyl ether sulfate salts, alkylphosphate salts, polyoxyethylene alkylether phosphate salts, polyoxyethylene alkylphenyl ether phosphate salts, styrene/maleic anhydride copolymer partial saponificates, olefin/maleic anhydride copolymer partial saponificates, naphthalenesulfonic acid salt/formalin condensates.

Not specifically defined, the cationic surfactants usable in the invention may be any known ones. For example, they include alkylamines salts, quaternary ammonium salts, polyoxyethylene alkylamine salts, polyethylene polyamine derivatives.

Not specifically defined, the ampholytic surfactants usable in the invention may be any known ones. For example, they include carboxybetaines, aminocarboxylic acids, sulfobetaines, aminosulfates imidazolines.

In the above surfactants, “polyoxyethylene” may be replaced with any other “polyoxyalkylene” such as polyoxymethylene, polyoxypropylene and polyoxybutylene; and all such surfactants are usable in the invention.

More preferred surfactants for use in the invention are fluorine-containing surfactants, which have a perfluoroalkyl group in the molecule. The fluorine-containing surfactants include, for example, anionic surfactants such as perfluoroalkylcarboxylic acid salts, perfluoroalkylsulfonic acid salts, perfluoroalkylphosphates; ampholytic surfactants such as perfluoroalkylbetaines; cationic surfactants such as perfluoroalkyltrimethylammonium salts; and nonionic surfactants such as perfluoroalkylamine oxide/perfluoroalkylethylene oxide adducts, oligomers having a perfluoroalkyl group and a hydrophilic group, oligomers having a perfluoroalkyl group and an oleophilic group, oligomers having a perfluoroalkyl group, a hydrophilic group and an oleophilic group, urethanes having a perfluoroalkyl group and an oleophilic group. In addition, the fluorine-containing surfactants described in JP-A 62-170950, 62-226143, 60-168144 are also favorably used herein.

The surfactant may be in the coating composition of the invention, preferably in an amount falling within a range of from 0.001 to 10% by mass relative to the nonvolatile component therein, more preferably from 0.01 to 5% by mass. One or more such surfactants may be in the composition either singly or as combined.

### [Inorganic Particles]

The coating composition of the invention may contain inorganic particles for improving the cured film strength of the hydrophilic film formed of it and for improving the hydrophilicity thereof. Preferred examples of the inorganic particles are, for example, silica, alumina, magnesium oxide, titanium oxide, magnesium carbonate, calcium alginate and their mixtures.

Preferably, the inorganic particles have a mean particle size of from 5 nm to 10 μm, more preferably from 0.5 to 3 μm. Within the range, the particles may stably disperse in the hydrophilic layer, thereby sufficiently keeping the film strength of the hydrophilic layer, and therefore a film having excellent hydrophilicity may be formed. The above-mentioned inorganic particles are readily available as commercial products of colloidal silica dispersion, etc.

The inorganic particles of the invention may be in the coating composition of the invention, preferably in an amount of at most 20% by mass relative to the nonvolatile component therein, more preferably at most 10% by mass. One or more different types of inorganic particles may be in the composition either singly or as combined.

### [UV Absorbent]

The coating composition of the invention may contain a UV absorbent for improving the weather resistance and the durability of the hydrophilic member.

The UV absorbent includes compounds capable of absorbing UV rays to emit fluorescence, or so-called fluorescent brighteners, typically for example, benzotriazole compounds as in JP-A 58-185677, 61-190537, 2-782, 5-197075, 9-34057; benzophenone compounds as in JP-A 46-2784, 5-194483, U.S. Pat. No. 3,214,463,; cinnamic acid compounds as in JP-B 48-30492, 56-21141, JP-A 10-88106; triazine compounds as in JP-A 4-298503, 8-53427, 8-239368, 10-182621, JP-T 8-501291; stilbene compounds and benzoxazole compounds as in Research Disclosure No. 24239.

Its amount to be added may be suitably determined depending on its use. In general, it is preferably from 0.5 to 15% by mass in terms of the solid content thereof in the composition.

### [Antioxidant]

An antioxidant may be added to the coating liquid for forming a hydrophilic layer of the invention, for the purpose of improving the stability of the hydrophilic member of the invention. The antioxidant is described in EP-A 223739, 309401, 309402, 310551, 310552, 459416, GE-A 3435443, JP-A 54-48535, 62-262047, 63-113536, 63-163351, 2-262654, 2-71262, 3-121449, 5-61166, 5-11-449, U.S. Pat. Nos. 4,814,262, 4,980,275.

Its amount to be added may be suitably determined depending on its use. In general, it is preferably from 0.1 to 8% by mass in terms of the solid content thereof in the composition.

### [Polymer Compound]

Various polymer compounds may be added to the coating liquid for forming a hydrophilic layer of the hydrophilic member of the invention, for the purpose of controlling the physical properties of the hydrophilic layer not detracting from the hydrophilicity of the layer. The polymer compounds include acrylic polymers, polyvinyl alcohol resins, polyvinylbutyral resins, polyurethane resins, polyamide resins, polyester resins, epoxy resins, phenolic resins, polycarbonate resins, polyvinylformal resins, shellac, vinylic resins, acrylic resins, rubber resins, waxes, and other natural resins. Two or more of these may be used, as combined. Of those, preferred are vinylic copolymers obtained through copolymerization of acrylic monomers. Regarding the copolymerization composition of the polymer binder, also preferred are copolymers containing “carboxyl group-having monomer”, “alkyl methacrylate” or “alkyl acrylate” as the structural unit thereof.

In addition to the above, if desired, the composition may also contain, for example, a leveling additive, a mat agent, a wax for controlling the physical properties of the film formed, and a tackifier for improving the adhesiveness of the film to a substrate not detracting from the hydrophilicity of the film.

The tackifier includes, for example, high-molecular-weight adhesive polymers described in JP-A 2001-49200, pp. 5-6 (e.g., copolymer comprising an ester of (meth)acrylic acid and an alcohol having an alkyl group having from 1 to 20 carbon atoms, an ester of (meth)acrylic acid and an alicyclic alcohol having from 3 to 14 carbon atoms, an ester of (meth)acrylic acid and an aromatic alcohol having from 6 to 14 carbon atoms); and low-molecular-eight tackifying resins having a polymerizing unsaturated bond.

### [Preparation of Coating Composition]

The coating composition may be prepared by dissolving the thermally-decomposing polymer (A) and the specific alkoxide (B) preferably along with a catalyst (C) in a solvent such as ethanol and stirring it. The reaction temperature is preferably from room temperature to 80° C.; and the reaction time, or that is, the time for which the system is stirred is preferably within a range of from 1 to 72 hours. The stirring promotes the hydrolysis and polycondensation of the two components to give an organic-inorganic hybrid sol liquid.

Not specifically defined, the solvent to be used in preparing the coating composition comprising the thermally-decomposing polymer (A) and the specific alkoxide (B) may be any one capable of uniformly dissolving and dispersing the components therein.

As described in the above, a sot-gel process is utilized in preparing the organic-inorganic hybrid sol liquid (coating liquid) to form a hydrophilic film of the coating composition of the invention. The sol-gel process is described in detail in published documents, such as Sumio Sakuhana, “Science of Sol-Gel Process” published by Agune Shofu-sha, 1988); Ken Hirashima, “Technique of Forming Functional Thin Film by Newest Sol-Gel Process” (published by General Technology Center, 1992). The methods described in these are applicable to preparing the coating composition of the invention.

The solution that contains the coating composition of the invention is applied onto a suitable support and dried thereon, thereby obtaining a hydrophilic member of the invention. Specifically, the hydrophilic member of the invention has a hydrophilic film formed as follows: The coating composition of the invention is applied onto a support to form a film thereon, and then this is heated to thereby decompose the thermally-decomposing group therein to give a hydrophilic group; or the coating composition is heated so as to decompose the thermally-decomposing group therein into a hydrophilic group, and the resulting hydrophilic composition is applied onto a support to form a film thereon and then this is dried.

Depending on the type of the thermally-decomposing group, the temperature at which the thermally-decomposing group is decomposed preferably falls within a range of from 50 to 250° C., but more preferably from 80 to 200° C. from the viewpoint of the risk for polymer decomposition and the boiling point of the solvent. Regarding the heating and drying condition for the coating composition-containing liquid to form the hydrophilic film, it is desirable that the film of the coating composition-containing liquid is heated and dried at a temperature falling within a range of from 50 to 200° C. for 2 minutes to 1 hour or so from the viewpoint of efficiently forming a high-density crosslinked structure, more preferably at a temperature falling within a range of from 80 to 160° C. for 5 to 30 minutes. Any known heating means may be employed for heating it. For example, preferably used is a drier having a temperature-controlling function.

### [Substrate]

Regarding the substrate usable as the support of the hydrophilic member of the invention, when the substrate is a transparent one expected to have an anti-soiling and/or anti-fogging effect, then it is preferably a transparent substrate capable of transmitting visible light, for example, an inorganic substrate of glass alone or glass that has an inorganic compound layer, or a transparent plastic alone or a transparent plastic layer combined with an inorganic compound layer.

The inorganic substrate is described in detail. It includes ordinary glass sheets; laminate glass sheets having a resin layer, a vapor layer, a vacuum layer; and other various glass sheets containing a reinforcing component and a colorant.

The glass sheet having an inorganic compound layer includes those provided with an inorganic compound layer formed of a metallic oxide such as silicon oxide, aluminium oxide, magnesium oxide, titanium oxide, tin oxide, zirconium oxide, sodium oxide, antimony oxide, indium oxide, bismuth oxide, yttrium oxide, cerium oxide zinc oxide, ITO (indium tin oxide); or a metal halide such as magnesium fluoride, calcium fluoride, lanthanum fluoride, cerium fluoride, lithium fluoride, sodium fluoride.

The inorganic compound layer may have a single-layer of multi-layer structure. Depending on its thickness, the inorganic compound layer may keep its light transmittance, or may serve as an antireflection layer. For forming the inorganic compound layer, employable is any known method, for example a coating method such as a dip coating method, a spin coating method, a flow coating method, a spray coating method, a roll coating method, a gravure coating method, as swell as a vapor-phase method such as typically a physical vapor deposition method (PVD) or a chemical vapor deposition method (CVD), e.g., a vacuum evaporation method, a reactive vapor deposition method, an ion beam-assisted deposition method, a sputtering method, an ion-plating method.

The transparent plastic substrate, a type of various organic substrates of plastics, may be formed of various plastic materials having visible ray transmittance. In particular, the substrate for optical members must be selected in consideration of the optical properties thereof such as the transparency, the refractivity and the dispersibility thereof, and therefore depending on its use, the substrate of the type may be selected in consideration of various properties thereof, for example, the physical properties such as strength, e.g., impact resistance and flexibility thereof, and also the heat resistance, the weather resistance and the durability thereof. From this viewpoint, preferred for use herein are polyolefin resins such as polyethylene, polypropylene; polyester resins such as polyethylene terephthalate, polyethylene naphthalate; polyamide resins; as well as polystyrene, polyvinyl chloride, polyimide, polyvinyl alcohol, ethylene vinyl alcohol, acrylic resins; and cellulose resins such as triacetyl cellulose, diacetyl cellulose, cellophine. Depending on their use, these may be used singly, or may be used as their mixtures, copolymers or laminates as combined.

The plastic substrate for use herein may comprise an inorganic compound layer such as that mentioned hereinabove for glass sheets, formed on a plastic sheet. In this case, the inorganic compound layer may serve as an antireflection layer. The inorganic compound layer may be formed on a plastic sheet in the same manner as that mentioned hereinabove for inorganic substrates.

When an inorganic compound layer is formed on a transparent plastic substrate, a hard coat layer may be formed between the two. The hard coat layer may improve the surface hardness of the substrate having it, and may smooth the substrate surface, and therefore, the adhesiveness between the transparent plastic substrate and the inorganic compound layer may be improved, the scratch resistance of the substrate may be improved, and the inorganic compound layer may be prevented from being cracked when the substrate is bent. Use of the substrate of the type improves the mechanical strength of the hydrophilic member. Not specifically defined, the hard coat layer may be formed of any material having transparency and suitable strength, e.g., mechanical strength. For example, the layer may be formed of a resin curable through irradiation with ionizing radiations or UV rays, or a thermosetting resin. Especially preferred are UV-curable acrylic resins, organosilicon resins, thermosetting polysiloxane resins. Preferably, the refractive index of the resin is on the same level as or is near to the refractive index of the transparent plastic substrate.

Not specifically defined, the hard coat layer may be formed in any method in which the layer may be formed uniformly. The thickness of the hard coat layer may be at least 3 μm for its sufficient strength, but is preferably within a range of from 5 to 7 μm in view of the transparency, the coating accuracy and the handlability thereof. Further, inorganic or organic particles having a mean particle size of from 0.01 to 3 μm may be mixed and dispersed in the hard coat layer for light diffusion treatment, or that is, antiglare treatment of the layer. Not specifically defined, the material of the particles may be any transparent one but is preferably one having a low refractive index. More preferred are silicon oxide and magnesium fluoride in view of their stability and heat resistance. The light diffusion treatment may also be attained by roughening the surface of the hard coat layer.

In the manner as above, the hydrophilic member of the invention may be produced by using such a glass sheet or plastic sheet having an inorganic compound layer formed thereon as a substrate, and forming a hydrophilic surface on it. As having such a hydrophilic film having excellent hydrophilicity and durability, formed on its surface, the hydrophilic member may give any one or both of excellent soiling resistance, especially soiling resistance to oil and fat soil, and excellent fogging resistance to the surface of a support (substrate).

The antireflection layer applicable to the surface of the hydrophilic member of the invention is not limited to the above-mentioned inorganic compound layer, but may be any known antireflection layer formed by laminating plural thin layers that differ in their reflectance and refractivity, thereby exhibiting an antireflection effect. The material of the layer may be any of inorganic compounds and organic compounds. In particular, the substrate having an inorganic compound layer formed as an antireflection film on its surface may be combined with the hydrophilic polymer chain of the invention applied to the surface thereof opposite to the antireflection layer-coated surface, thereby giving an anti-soiling and/or anti-fogging member of the invention having excellent surface soiling resistance and/or fogging resistance and excellent antireflection capability. Depending on its object, the member having the above-mentioned constitution may be combined with a functional optical member such as a polarizer, for example, according a technique of typically lamination or the like. Thus using the hydrophilic member of the invention, antireflective, optically-functional members having various functions and characteristics may be obtained.

Using a sticking agent or an adhesive agent, the antireflection member or the antireflective, optically-functional member may be stuck to the glass sheet, the plastic sheet or the polarizer of the front image screen of various display devices (e.g., liquid-crystal displays, CRT displays, projection displays, plasma displays, EL displays), whereby the antireflection member may be applied to those display devices.

Apart from the above-mentioned display devices, the hydrophilic member of the invention is usable in any other various applications that require anti-soiling and/or anti-fogging effect. In case where the anti-soiling and/or anti-fogging member is applied to a substrate not requiring transparency, for example, metals, ceramics, wood, stones, cement, concrete, fibers, fabrics and their combinations and laminates may be favorably used as the supporting substrate for the member, in addition to the above-mentioned substrates.

### EXAMPLES

The invention is described in more detail with reference to the following Examples, to which, however, the invention should not be limited.

### (Production of Thermally-Decomposing Polymer (I-1))

23.9 g of a sulfonate monomer (1) represented by the formula below, 1.2 g of acrylamide-3-(ethoxysilyl)propyl, and 101.7 g of 1-methoxy-2-propanol were put into a 500-ml three-neck flask, and 0.33 g of dimethyl 2,2′-azobis(2-methylpropionate) was added thereto in a nitrogen atmosphere at 80° C. This was kept at that temperature with stirring for 6 hours, and then cooled to room temperature. The solvent was evaporated away, and the resulting solid was washed with hexane to obtain Compound (I-1), a type of the thermally-decomposing polymer (I-1). After dried, its mass was 21.6 g. Through GPC (polyethylene oxide standard), it was a polymer having a mass-average molecular weight 8,500.

### (Production of Thermally-Decomposing Polymer (II-1))

20.6 g of a sulfonate monomer (2) represented by the formula below, 0.35 g of 3-mercaptopropyltiethoxysilane, and 84.0 g of 1-methoxy-2-propanol were put into a 500-ml three-neck flask, and 0.05 g of dimethyl 2,2′-azobis(2-methylpropionate) was added thereto in a nitrogen atmosphere at 80° C. This was kept at that temperature with stirring for 6 hours, and then cooled to room temperature. The solvent was evaporated away, and the resulting solid was washed with hexane to obtain Compound (II-1), a type of the thermally-decomposing polymer (II-1). After dried, its mass was 19.9 g. Through GPC (polyethylene oxide standard), it was a polymer having a mass-average molecular weight 9,000.

Hereinafter, the thermally-decomposing polymer used in the Examples were produced according to any of the above methods, and used for evaluation.

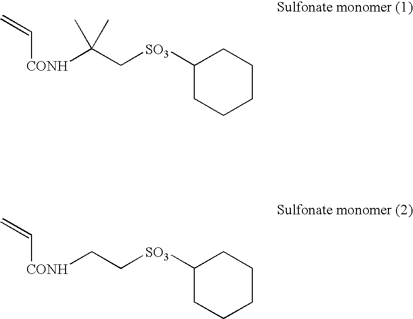

### [Preparation of Coating Composition (Sol-Gel Liquid)]

<Coating composition 1>

| | | |
|---|---|---|
| (A) Thermally-decomposing polymer | 25 | parts by mass |
| (compound in Table 1) | | |
| (B) Alkoxide compound (compound in Table 1) | 75 | parts by mass |
| Distilled water | 68 | parts by mass |
| Ethanol | 68 | parts by mass |
| Dimethyl sulfoxide | 1008 | parts by mass |

<Coating composition 2>

| | | |
|---|---|---|
| (A) Thermally-decomposing polymer | 22 | parts by mass |
| (compound in Table 1) | | |
| (B) Alkoxide compound (compound in Table 1) | 67 | parts by mass |
| (C) Catalyst (compound in Table 1) | 11 | parts by mass |
| Distilled water | 68 | parts by mass |
| Ethanol | 68 | parts by mass |
| Dimethyl sulfoxide | 1008 | parts by mass |

### [Production of surface hydrophilic member]

### (Production method 1)

The ingredients of the above coating composition 1 were uniformly mixed, and stirred at 20° C. for 2 hours for hydrolysis to obtain a sol-like coating composition. The coating composition was applied onto a substrate, glass sheet (by Endo Science) in such a manner that the coating amount thereof after dried could be 0.1 g/m², and then heated at 150° C. for 30 minutes whereby the thermally-decomposing group was converted into a hydrophilic group. Thus, a surface hydrophilic member having a hydrophilic layer formed on the substrate was obtained.

### (Production Method 1)

Of the ingredients of the above coating composition 2, the thermally-decomposing polymer (A) and dimethyl sulfoxide were uniformly mixed, and stirred at 150° C. for 1 hour to thereby convert the thermally-decomposing group into a hydrophilic group in the mixture. After left cooled, the remaining ingredients were added to the mixture, and stirred at 20° C. for 2 hours for hydrolysis to obtain a sol-like coating composition. The coating composition was applied onto a substrate, glass sheet (by Endo Science) in such a manner that the coating amount thereof after dried could be 0.1 g/m², and then heated at 150° C. for 30 minutes thereby giving a surface hydrophilic member having a hydrophilic layer formed on the substrate.

The details of Examples are shown in Table 1 along with the evaluation test results thereof.

### COMPARATIVE EXAMPLE 1

A surface hydrophilic member of Comparative Example 1 was obtained in the same manner as in Example 5, for which, however, a comparative hydrophilic polymer (i) having the following structure not falling within the scope of the invention [in Table 1, this is “comparative hydrophilic polymer (i)] was used in place of the thermally-decomposing polymer (I-1) falling within the scope of the invention.

### COMPARATIVE EXAMPLE 2

A surface hydrophilic member of Comparative Example 2 was obtained in the same manner as in Example 5, for which, however, a comparative hydrophilic polymer (ii) having the following structure not falling within the scope of the invention [in Table 1, this is “comparative hydrophilic polymer (ii)] was used in place of the thermally-decomposing polymer (I-1) falling within the scope of the invention.

### COMPARATIVE EXAMPLE 3

In place of the hydrophilic film of the invention, the photocatalyst film (TOTO's Hydrotect) was stuck to the surface of the support used in the above Examples, thereby producing a surface hydrophilic member of Comparative Example 3.

### [Evaluation of Hydrophilic Member]

### [Surface Free Energy]

The degree of hydrophilicity of the surface of a hydrophilic layer is generally measured, based on the contact angle to a water drop thereon (Kyowa Interface Science's Drop Master 500). However, on the surface having extremely high hydrophilicity as in the invention, the water drop contact angle may be at most 10°, even at most 5°; and therefore, the method may be limitative for mutual comparison of the degree of hydrophilicity of the surface. On the other hand, for evaluating the degree of hydrophilicity of a solid surface in more detail, there is known a method of measuring surface free energy. Various methods have been proposed for it. In the invention, a Zisman plotting method was employed as an example of measuring surface free energy. Concretely, the method is as follows: Based on the phenomenon that an aqueous solution of an inorganic electrolyte such as magnesium chloride may have a larger surface tension increasing with the increase in its concentration, the contact angle of a sample is measured in air at room temperature using the aqueous solution. The data with the aqueous solution having a different concentration are plotted on a graph, in which the horizontal axis indicates the surface tension of the aqueous solution and the vertical axis indicates the contact angle as coso. The graph gives a linear relationship between the two parameters. The surface tension that gives cos θ=1, or that is, contact angle=0° is defined as the surface free energy of the solid analyzed according to the method. The surface tension of water is 72 mN/m, and it may be said that the samples having a larger value of surface free energy have a higher degree of hydrophilicity.

### [Transparency]

When the transparent member coated with the hydrophilic film of the invention is used for windowpanes, its transparency is important for securing view through it. The hydrophilic film of the invention has excellent transparency, and even though it is thick, its transparency does not lower. Accordingly, the hydrophilic member of the invention may satisfy both transparency and durability.

The transparency of the member may be evaluated by measuring the light transmittance through it within a visible light range (400 nm to 800 nm), using a spectrophotometer (Hitachi Spectrophotometer U3000).

### [Evaluation of Abrasion Resistance]

The surface of the hydrophilic member obtained is rubbed with a nonwoven fabric (Asahi Chemical Fibers' BEMCOT) under a load of 200 g applied thereto, in a reciprocating motion repeatedly 250 times. Before and after the rubbing test, the sample is visually checked for appearance change.
A: No fault found in the surface after the test.
B: A fault found after the test.
C: Many faults found after the test.

### [Scratch Resistance]

The surface of the hydrophilic layer is scanned with a 0.1-mm diameter sapphire needle while the load applied thereto is varied, starting from 5 g, at regular intervals of 5 g; and the load under which the layer has come to be scratched is measured (with Shinto Science's Scratch Strength Tester Type 18S). This indicates the scratch resistance of the sample. Samples not scratched under a higher load have better durability.

### [Evaluation of Fogging Resistance]

The hydrophilic member obtained in the above is exposed to water vapor for 1 minute under a fluorescent lamp in a room in the daytime. After it is separated from water vapor, it is put in an environment at 25° C. and 10% RH, and then again exposed to the fluorescent lamp under the same condition as previously. Then, the sample is checked for fogging and change, and is organoleptically evaluated as in the following three ranks:
A: No fogging found.
B: Fogged but the fogging disappeared within 10 seconds, and no more fogging found thereafter.
C: Fogged, and the fogging did not disappear even after 10 seconds.

### [Evaluation of Soiling Resistance]

A line is drawn on the surface of the hydrophilic member obtained in the above, using an oily ink (Mitsubishi Pencil's oily marker), then a water jet is continuously applied thereto, and the sample is checked whether the line could be erased off, and is organoleptically evaluated as in the following three ranks:
A: Ink was removed within 1 minute.
B: Ink was removed after 1 minute.
C: Even after 2 minutes, ink was not removed over 10 minutes.

The evaluation test results are shown in Table 1 below.

TABLE 1

| | Constitutive Components of Hydrophilic Composition | | | |
|---|---|---|---|---|
| | Thermally- | | | |
| | Decomposing | Specific | | |
| | Polymer (A) | Alkoxide (B) | Catalyst (C) | Production Method |
| Example 1 | Thermally- | Tetramethoxy- | no | Production Method 1 |
| | Decomposing | silane | | |
| | Polymer (I-1) | | | |
| Example 2 | Thermally- | Tetramethoxy- | no | Production Method 2 |
| | Decomposing | silane | | |
| | Polymer (I-1) | | | |
| Example 3 | Thermally- | Tetramethoxy- | no | Poduction Method 1 |
| | Decomposing | silane | | |
| | Polymer (II-1) | | | |
| Example 4 | Thermally- | Tetramethoxy- | no | Production Method 2 |
| | Decomposing | silane | | |
| | Polymer (II-1) | | | |
| Example 5 | Thermally- | Tetramethoxy- | Titanium | Production Method 1 |
| | Decomposing | silane | Acetylacetonate | |
| | Polymer (I-1) | | | |
| Example 6 | Thermally- | Tetramethoxy- | Titanium | Production Method 1 |
| | Decomposing | silane | Acetylacetonate | |
| | Polymer (I-3) | | | |
| Example 7 | Thermally- | Tetramethoxy- | Titanium | Production Method 1 |
| | Decomposing | silane | Acetylacetonate | |
| | Polymer (I-4) | | | |
| Example 8 | Thermally- | Tetramethoxy- | Titanium | Production Method 1 |
| | Decomposing | silane | Acetylacetonate | |
| | Polymer (I-22) | | | |
| Example 9 | Thermally- | Tetramethoxy- | Titanium | Production Method 1 |
| | Decomposing | silane | Acetylacetonate | |
| | Polymer (I-10) | | | |
| Example 10 | Thermally- | Tetramethoxy- | Titanium | Production Method 1 |
| | Decomposing | silane | Acetylacetonate | |
| | Polymer (II-1) | | | |
| Example 11 | Thermally- | Tetramethoxy- | Titanium | Production Method 1 |
| | Decomposing | silane | Acetylacetonate | |
| | Polymer (II-4) | | | |
| Example 12 | Thermally- | Tetramethoxy- | Titanium | Production Method 1 |
| | Decomposing | silane | Acetylacetonate | |
| | Polymer (II-17) | | | |
| Example 13 | Thermally- | Tetramethoxy- | Titanium | Production Method 1 |
| | Decomposing | silane | Acetylacetonate | |
| | Polymer (II-22) | | | |
| Example 14 | Thermally- | Tetramethoxy- | Titanium | Production Method 1 |
| | Decomposing | silane | Acetylacetonate | |
| | Polymer (II-10) | | | |
| Example 15 | Thermally- | Tetramethoxy- | Nitric Acid | Production Method 1 |
| | Decomposing | silane | | |
| | Polymer (I-1) | | | |
| Example 16 | Thermally- | Tetramethoxy- | Hydrochloric | Production Method 2 |
| | Decomposing | silane | Acid | |
| | Polymer (II-1) | | | |
| Example 17 | Thermally- | Aluminium | Titanium | Production Method 1 |
| | Decomposing | Ethoxide | Acetylacetonate | |
| | Polymer (I-1) | | | |
| Example 18 | Thermally- | Zirconium | Titanium | Production Method 1 |
| | Decomposing | Ethoxide | Acetylacetonate | |
| | Polymer (I-1) | | | |
| Example 19 | Thermally- | Titanium | Titanium | Production Method 1 |
| | Decomposing | Ethoxide | Acetylacetonate | |
| | Polymer (I-1) | | | |
| Comparative | Comparative | Tetramethoxy- | Titanium | Production Method 1 |
| Example 1 | Hydrophilic | silane | Acetylacetonate | |
| | Polymer (i) | | | |
| Comparative | Comparative | Tetramethoxy- | Titanium | Production Method 1 |
| Example 2 | Hydrophilic | silane | Acetylacetonate | |
| | Polymer (ii) | | | |

| Comparative | Photocatalyst Film | | | | | |
|---|---|---|---|---|---|---|
| Example 3 | | | | | | |
| | Evaluation of Properties | | | | | |
| | Surface | | | | | |
| | Free | Light | Abrasion | Scratch | Fogging | Soiling |
| | Energy | Transmittance | Resistance | Resistance | Resistance | Resistance |
| Example 1 | 79 mN/m | 90% | B | 10 g | A | A |
| Example 2 | 80 mN/m | 90% | B | 15 g | A | A |
| Example 3 | 85 mN/m | 94% | B | 5 g | A | A |
| Example 4 | 84 mN/m | 90% | B | 10 g | A | A |
| Example 5 | 79 mN/m | 89% | A | 90 g | A | A |
| Example 6 | 80 mN/m | 91% | A | 85 g | A | A |
| Example 7 | 81 mN/m | 87% | A | 95 g | A | A |
| Example 8 | 76 mN/m | 89% | A | 80 g | A | B |
| Example 9 | 77 mN/m | 90% | A | 100 g | A | B |
| Example 10 | 83 mN/m | 84% | A | 95 g | A | A |
| Example 11 | 81 mN/m | 85% | A | 100 g | A | A |
| Example 12 | 84 mN/m | 88% | A | 85 g | A | A |
| Example 13 | 77 mN/m | 91% | A | 90 g | A | A |
| Example 14 | 76 mN/m | 90% | A | 100 g | A | A |
| Example 15 | 81 mN/m | 93% | A | 100 g | A | A |
| Example 16 | 84 mN/m | 91% | A | 90 g | A | A |
| Example 17 | 80 mN/m | 90% | A | 105 g | A | A |
| Example 18 | 79 mN/m | 88% | A | 95 g | A | A |
| Example 19 | 79 mN/m | 92% | A | 100 g | A | A |
| Comparative | 70 mN/m | 80% | B | 5 g | C | C |
| Example 1 | | | | | | |
| Comparative | 69 mN/m | 85% | C | <5 g | C | C |
| Example 2 | | | | | | |
| Comparative | 90 mN/m | 90% | C | <5 g | A | A |
| Example 3 | | | | | | |

The comparative hydrophilic polymers (i) and (ii) and the alkoxide compound (B) in the above Table 1 are as follows:

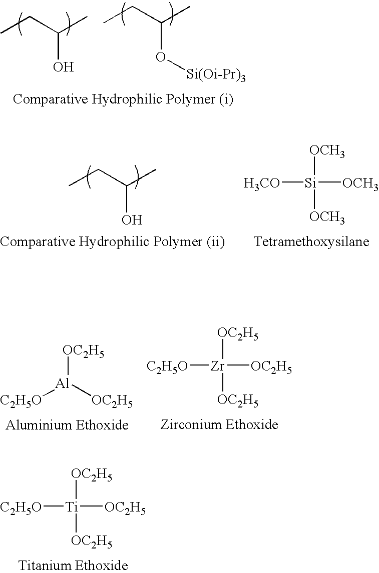

As is obvious from Table 1, the hydrophilic film formed of the coating composition of the invention had excellent soiling resistance, fogging resistance and abrasion resistance. The hydrophilic film formed with the comparative hydrophilic polymer (i) (Comparative Example 1) had neither soiling resistance nor fogging resistance as its hydrophilicity was poor. In Comparative Example 2, the comparative hydrophilic polymer (ii) did not have a silane-coupling group, and therefore, not only the hydrophilicity but also the abrasion resistance and the scratch resistance of the sample was poor. Comparing Examples 1 to 4 with Examples 5 to 19 confirms that the catalyst added in forming the hydrophilic film further improved the abrasion resistance of the film formed. Not depending on the production method employed, highly hydrophilic members of high quality were produced in both methods. Further, it was made clear that use of the thermally-decomposing polymer having a silane-coupling group bonding to its terminal gives a film of higher hydrophilicity than the thermally-decomposing polymer having a silane-coupling group bonding to its side branch. This may be presumed because the polymer chain may freely move in the outermost surface of the film. On the other hand, the hydrophilic member produced by sticking a photocatalyst film onto a glass substrate (Comparative Example 3) has poor abrasion resistance and poor scratch resistance, and its practical use is problematic.

According to the invention, there are provided a coating composition useful for forming a hydrophilic film having excellent soiling resistance and fogging resistance and having better abrasion resistance, on the surface of various substrates; and an anti-soiling and anti-fogging hydrophilic member having the hydrophilic film.

Examples of the applications of the hydrophilic member of the invention are described. The applications in which the substrate is transmissive to visible light include mirrors such as rearview mirrors for vehicles, mirrors in bathrooms, mirrors in washrooms, mirrors for dental use, road mirrors; lenses such as eyeglass lenses, optical lenses, camera lenses, endoscope lenses, lenses for illumination, lenses for semiconductors, lenses for duplicators; prisms; windowpanes for buildings, control towers; windowpanes for vehicles, such as cars, railroad carriages, airplanes, ships, midget submarines, snowmobiles, ropeway gondolas, gondolas in amusement parks, spaceships; windshields for vehicles, such as cars, railroad carriages, airplanes, ships, midget submarines, snowmobiles, motorcycles, ropeway gondolas, gondolas in amusement parks, spaceships; protector goggles, sports goggles, protector mask shields, sports mask shields, helmet shields, glass cases for frozen food display; cover glass for metering instruments; and films to be stuck to the surface of the above articles.

The other applications include building materials, building exterior materials, building interior materials, window frames, windowpanes, structural members, exterior and coating materials for vehicles, exterior materials for machinery and articles, dust covers and coatings, traffic signs, various display devices, advertising towers, road noise barriers, railroad noise barriers, bridges, guardrail exterior and coating materials, tunnel interior and coating materials, insulators, solar cell covers, heat collector covers for solar heaters, plastic greenhouses, cover for vehicle lights, housing equipment, toilets, bathtubs, washstands, lighting instruments, lighting instrument covers, kitchen utensils, dishes, dish washers, dish driers, sinks, cooking ovens, kitchen hoods, ventilation fans, and films to be stuck to the surface of the above articles; as well as housings, parts, exterior materials and coating materials of electric appliances for household use, housings, parts, exterior materials and coating materials of electric appliances for OA appliances, and films to be stuck to the surface of the above articles. Thus, the range of the applications is broad.

The entire disclosure of each and every foreign patent application from which the benefit of foreign priority has been claimed in the present application is incorporated herein by reference, as if fully set forth.

What is claimed is:

1. A coating composition comprising:
(A) a thermally-decomposing polymer selected from a thermally-decomposing polymer (1) and a thermally-decomposing polymer (2); and
(B) an alkoxide compound of an element selected from Si, Ti, Zr and Al,
wherein the thermally-decomposing polymer (1) has a structural unit represented by the following general formula (I-a) and a structural unit represented by the following general formula (I-b), and
the thermally-decomposing polymer (2) has a structural unit represented by the following general formula (II-b) and has a functional group represented by the following general formula (II-a) at the terminal of the polymer chain: 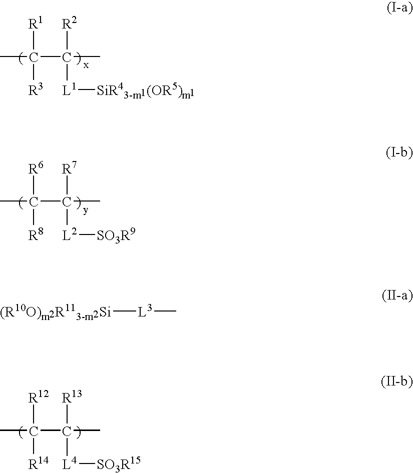
wherein R¹ to R¹⁵ each independently represents a hydrogen atom or a hydrocarbon group having 8 or less carbon atoms,
L¹, L² and L⁴ each independently represents a single bond or a polyvalent organic linking group,
L³ represents a divalent organic linking group,
m¹ and m² each independently represents an integer of from 1 to 3, and
x and y each is a number of from 0 to 100 with the proviso that x+y=100.

2. The coating composition according to claim 1, further comprising:
(C) a catalyst that promotes the reaction of (A) the thermally-decomposing polymer and (B) the alkoxide compound.

3. A hydrophilic member comprising:
a support; and
a hydrophilic film that is formed by applying a coating composition onto the support and heating the coating composition, thereby decomposing a thermally-decomposing group in the coating composition to give a hydrophilic group,
wherein the coating composition comprises:
(A) a thermally-decomposing polymer selected from a thermally-decomposing polymer (1) and a thermally-decomposing polymer (2), and
(B) an alkoxide compound of an element selected from Si, Ti, Zr and Al,
wherein the thermally-decomposing polymer (1) has a structural unit represented by the following general formula (I-a) and a structural unit represented by the following general formula (I-b), and
the thermally-decomposing polymer (2) has a structural unit represented by the following general formula (II-b) and has a functional group represented by the following general formula (II-a) at the terminal of the polymer chain: 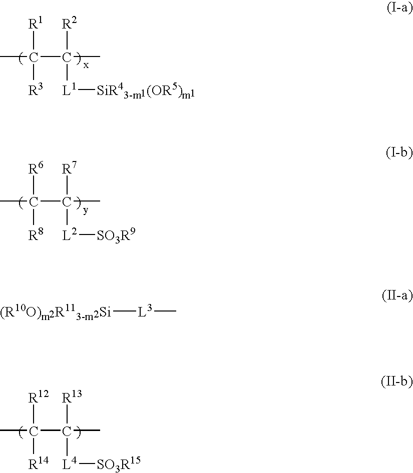
wherein R¹ to R¹⁵ each independently represents a hydrogen atom or a hydrocarbon group having 8 or less carbon atoms,
L¹, L² and L⁴ each independently represents a single bond or a polyvalent organic linking group,
L³ represents a divalent organic linking group,
m¹ and m² each independently represents an integer of from 1 to 3, and
x and y each is a number of from 0 to 1 00 with the proviso that x+y=100.

4. The hydrophilic member according to claim 3,
wherein the coating composition further comprises:
(C) a catalyst that promotes the reaction of (A) the thermally-decomposing polymer and (B) the alkoxide compound.

5. A production method of a hydrophilic member comprising:
a process of preparing a coating composition that comprises:
(A) a thermally-decomposing polymer selected from a thermally-decomposing polymer (1) and a thermally-decomposing polymer (2), and
(B) an alkoxide compound of an element selected from Si, Ti, Zr and Al;
a process of applying the coating composition onto a support;
a process of heating the coating composition to form a hydrophilic film, thereby decomposing a thermally-decomposing group in (A) the thermally-decomposing polymer to give a hydrophilic group,
wherein the thermally-decomposing polymer (1) has a structural unit represented by the following general formula (I-a) and a structural unit represented by the following general formula (I-b), and
the thermally-decomposing polymer (2) has a structural unit represented by the following general formula (II-b) and has a functional group represented by the following general formula (II-a) at the terminal of the polymer chain: 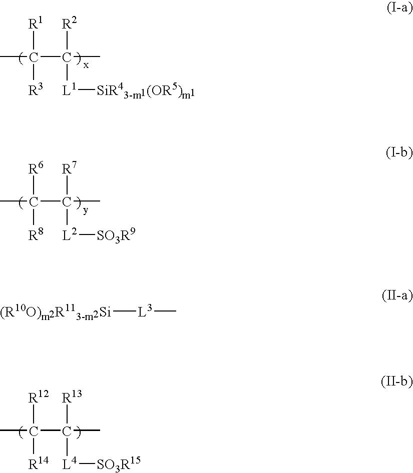
wherein R¹ to R¹⁵ each independently represents a hydrogen atom or a hydrocarbon group having 8 or less carbon atoms,
L¹, L² and L⁴ each independently represents a single bond or a polyvalent organic linking group,
L³ represents a divalent organic linking group,
m¹ and m² each independently represents an integer of from 1 to 3, and
x and y each is a number of from 0 to 100 with the proviso that x+y=100.

6. A coating composition comprising:
(A′) a hydrophilic polymer selected from a hydrophilic polymer (1) and a hydrophilic polymer (2); and
(B) an alkoxide compound of an element selected from Si, Ti, Zr and Al,
wherein the hydrophilic polymer (1) is formed by heating a thermally-decomposing polymer (1) having a structural unit represented by the following general formula (I-a) and a structural unit represented by the following general formula (I-b), thereby decomposing a thermally-decomposing group in the thermally-decomposing polymer (1) to give a hydrophilic group, and
the hydrophilic polymer (2) is formed by heating a thermally-decomposing polymer (2) having a structural unit represented by the following general formula (II-b) and has a functional group represented by the following general formula (II-a) at the terminal of the polymer chain, thereby decomposing a thermally-decomposing group in the thermally-decomposing polymer (2) to give a hydrophilic group: 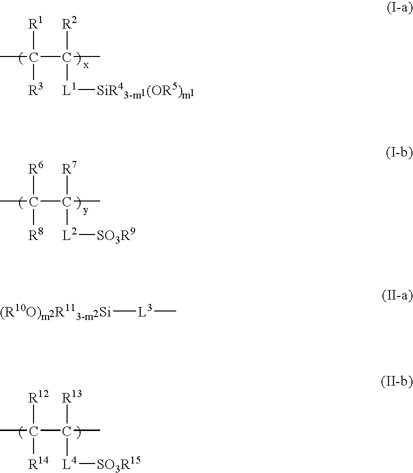
wherein R¹ to R¹⁵ each independently represents a hydrogen atom or a hydrocarbon group having 8 or less carbon atoms,
L¹, L² and L⁴ each independently represents a single bond or a polyvalent organic linking group,
L³ represents a divalent organic linking group,
m¹ and m² each independently represents an integer of from 1 to 3, and
x and y each is a number of from 0 to 100 with the proviso that x+y=100.

7. The coating composition according to claim 6, further comprising:
(C) a catalyst that promotes the reaction of (A′) the hydrophilic polymer and (B) the alkoxide compound.

8. A hydrophilic member comprising:
a support; and
a hydrophilic film that is formed by applying a coating composition onto the support, and heating and drying the coating composition,
wherein the coating composition comprises:
(A′) a hydrophilic polymer selected from a hydrophilic polymer (1) and a hydrophilic polymer (2), and
(B) an alkoxide compound of an element selected from Si, Ti, Zr and Al,
wherein the hydrophilic polymer (1) is formed by heating a thermally-decomposing polymer (1) having a structural unit represented by the following general formula (I-a) and a structural unit represented by the following general formula (I-b), thereby decomposing a thermally-decomposing group in the thermally-decomposing polymer (1) to give a hydrophilic group, and
the hydrophilic polymer (2) is formed by heating a thermally-decomposing polymer (2) having a structural unit represented by the following general formula (II-b) and has a functional group represented by the following general formula (II-a) at the terminal of the polymer chain, thereby decomposing a thermally-decomposing group in the thermally-decomposing polymer (2) to give a hydrophilic group: 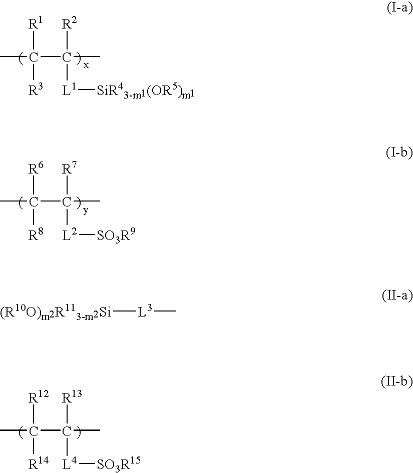
wherein R¹ to R¹⁵ each independently represents a hydrogen atom or a hydrocarbon group having 8 or less carbon atoms,
L¹, L² and L⁴ each independently represents a single bond or a polyvalent organic linking group,
L³ represents a divalent organic linking group,
m¹ and m² each independently represents an integer of from 1 to 3, and
x and y each is a number of from 0 to 100 with the proviso that x+y=100.

9. The hydrophilic member according to claim 8,
wherein the coating composition further comprises:
(C) a catalyst that promotes the reaction of (A′) the hydrophilic polymer and (B) the alkoxide compound.

10. A production method of a hydrophilic member comprising:
a process of preparing a coating composition that comprises:
(A′) a hydrophilic polymer selected from a hydrophilic polymer (1) and a hydrophilic polymer (2), and
(B) an alkoxide compound of an element selected from Si, Ti, Zr and Al, heating (A) a thermally-decomposing polymer to form (A′) a hydrophilic polymer;
a process of applying the coating composition onto a support; and
a process of heating and drying the coating composition to form a hydrophilic film,
wherein the hydrophilic polymer (1) is formed by heating a thermally-decomposing polymer (1) having a structural unit represented by the following general formula (I-a) and a structural unit represented by the following general formula (I-b), thereby decomposing a thermally-decomposing group in the thermally-decomposing polymer (1) to give a hydrophilic group and
the hydrophilic polymer (2) is formed by heating a thermally-decomposing polymer (2) having a structural unit represented by the following general formula (II-b) and has a functional group represented by the following general formula (II-a) at the terminal of the polymer chain, thereby decomposing a thermally-decomposing group in the thermally-decomposing polymer (2) to give a hydrophilic group: 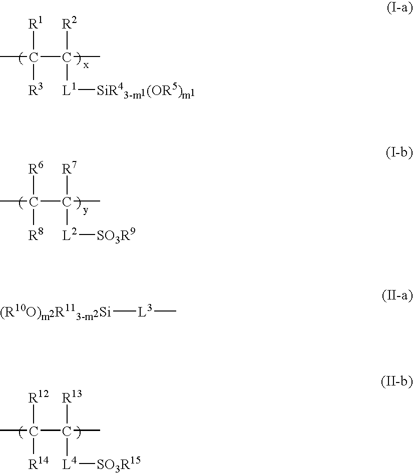
wherein R¹ to R¹⁵ each independently represents a hydrogen atom or a hydrocarbon group having 8 or less carbon atoms,
L¹, L² and L⁴ each independently represents a single bond or a polyvalent organic linking group,
L³ represents a divalent organic linking group,
m¹ and m² each independently represents an integer of from 1 to 3, and
x and y each is a number of from 0 to 100 with the proviso that x+y=100.
